(19) United States
(12) Patent Application Publication
(10) Pub. No.: US 2012/0057100 A1
(43) Pub. Date: Mar. 8, 2012

(54) OPTICAL MEMBERS AND DEVICES EMPLOYING THE SAME

(76) Inventors: Shoichi Masuda, Tokyo (JP); Atsushi Toyota, Kanagawa (JP); Naoya Taniguchi, Kanagawa (JP); Shinichiro Nakamura, Kanagawa (JP); Masaru Iwasawa, Kanagawa (JP); Jiro Hattori, Kanagawa (JP)

(21) Appl. No.: 13/320,345

(22) PCT Filed: May 17, 2010
(86) PCT No.: PCT/US2010/035055

§ 371 Date: Nov. 14, 2011

(30) Foreign Application Priority Data
May 18, 2009 (JP) 2009-120416

(51) Int. Cl. G02F 1/13357; F21V 5/04; G02B 27/22; G02B 27/12

(52) U.S. Cl. 349/62; 359/619; 362/311.01; 362/311.02; 362/97.1; 359/463

(57) ABSTRACT

There are provided optical members having a microlens array structure that can be produced by a more simple process, as well as devices employing them. The optical members have on one main surface a microlens array formed using a replication process that employs a mold comprising a plurality of gas bubbles arranged on a replication surface. There are also provided devices that employ the optical members.

### FIELD OF THE INVENTION

The present invention relates to optical members and to devices employing them, and in particular it relates to optical members comprising a lens array produced by a process utilizing gas bubbles, and to illumination devices, display devices or input devices employing the same.

### RELATED BACKGROUND ART

Known processes for producing microlens arrays include working processes such as polishing or pressing with spherical indenters, or formation of dies with multiple concavities by electron beam tracing and use of the dies for injection molding, compression molding, casting or the like. However, these processes generally require considerable time and cost for production of dies.

Japanese Patent Application Laid-Open No.1987 (S62)-260104 describes production by laser Chemical Vapor Deposition (“CVD”) as an alternative microlens array production process. In this process, the energy distribution of the laser light is adjusted to form individual lenses by laser CVD. In addition, Japanese Patent Application Laid-Open No. 1993(H5)-134103 describes a process for producing a microlens array by first preparing a lattice-like box frame, setting a resin therein and melting the resin, to form microlens curved surfaces by the surface tension of the melted resin.

C. Y. Chang et al. reported a manufacturing method for a microlens array made of a resin material in Infrared Physics & Technology 48, pp.163-173 (2006). The report describes a process for producing a microlens array composed of a resin material using gas pressure. In this production process, a resin film is set on mold disposed in a sealed chamber and a high gas pressure is applied, thereby extruding the resin film into the concavity of the mold and forming numerous convex curved surfaces in the resin film, to obtain a microlens array.

### SUMMARY OF THE INVENTION

Most of the conventional processes for microlens arrays mentioned above are complex and time-consuming production processes, and it is therefore desirable to produce microlens arrays more rapidly by a simpler process.

One aspect of the present invention is an optical member that includes a main surface and a microlens array on the main surface, wherein the microlense array are formed using a replication process that employs a mold having a plurality of gas bubbles arranged on a replication surface.

Another aspect of the present invention is an optical member that includes a main surface, a plurality of convex lenses arranged on the main surface, and partition walls adjacent to each convex lens and surrounding each convex lens.

Yet another aspect of the present invention is an optical member that includes a main surface, a plurality of concave lenses arranged on the main surface, and grooves adjacent to each concave lens and surrounding each concave lens.

Still another aspect of the present invention is an illumination device that includes a luminescent member and any of the aforementioned optical members disposed on the luminescent member.

Still another aspect of the present invention is a display device that includes a light-shielding pattern and any of the aforementioned optical members disposed on the light-incident side of the light-shielding pattern.

Still another aspect of the present invention is an input device that includes an input screen on which are arranged a plurality of input keys, a light source, and a light-guide member having any of the aforementioned optical members, which is disposed under the input screen and directs light from the light source to the region on the input screen corresponding to each of the input keys.

Still another aspect of the invention is a sheeting that includes a microlens array having a main surface and a plurality of convex lenses formed by replication of gas bubble shape arranged on the main surface, wherein each of the convex lenses is adjacent to and surrounded by partition walls that are higher than the convex lenses, a protective material disposed on the microlens array so as to supported by the partition walls, and a radiation sensitive layer disposed on a surface that is on an opposite side of the main surface of the microlens array.

The optical member of the present invention allows a concave or convex microlens array to be formed by replication of gas bubble shape, so that it can be provided using a rapid and simple process. The microlenses obtained by replication of gas bubble shape are lenses with smooth curved surfaces that are difficult to obtain by polishing.

Moreover, since the optical member according to a different aspect of the present invention has convex lenses and partition walls surrounding them or concave lenses and grooves surrounding them, it is possible to add to the function of the convex lenses or concave lenses, also the function of the shapes of the partition walls or grooves.

Furthermore, illumination devices, display devices or input devices employing such optical members of the invention can exhibit improved light utilization efficiency by the use of the optical members.

### BRIEF DESCRIPTION OF THE DRAWINGS

FIG. 1a to 1d are a set of simplified partial cross-sectional views showing a shape of an optical member according to an embodiment of the invention.

FIGS. 2a to 2c are a set of simplified partial cross-sectional views showing another example of the shape of an optical member according to an embodiment of the invention.

FIGS. 3a to 3d and FIGS. 4e to 4g are simplified process drawings showing an example of a process for producing an optical member according to an embodiment of the invention.

FIGS. 5a to 5d and FIGS. 6e to 6g are simplified process drawings showing an example of a process for producing an optical member according to an embodiment of the invention.

FIGS. 7a and 7b are partial front views showing an example shape of a base mold used in a process for producing an optical member according to an embodiment of the invention, and FIG. 7c is a simplified partial cross-sectional view showing another base mold example.

FIG. 8 is a simplified partial cross-sectional view showing the relationship between the base mold and a curable fluid, with a gas bubble trapped therebetween, in a production process for an optical member according to an embodiment of the invention.

FIGS. 9a and 9b are simplified structural views showing examples of an illumination device employing an optical member according to an embodiment of the invention.

FIG. 10a and FIG. 10b is a pair of simplified partial cross-sectional views showing an example of a structure for an illumination device employing an optical member according to an embodiment for organic electroluminescence.

FIG. 11 is a partial front view showing a lattice-like light-shielding pattern that can be used according to an embodiment of the invention.

FIG. 12a is a simplified diagram of a display device, showing an example for application of an optical member according to an embodiment of the invention to a display with a black matrix as a lattice-like light-shielding pattern, and FIG. 12b is a partial cross-sectional view showing an example of a structure for the black matrix and the optical member according to an embodiment of the invention.

FIG. 13 is a partial front view showing an example of a structure for a black matrix and an optical member, in a case when the optical member according to an embodiment of the invention is applied to a display having a black matrix as a lattice-like light-shielding pattern.

FIG. 14a is a perspective view of an example of a light guide employing an optical member according to an embodiment of the invention, FIG. 14b is a magnified partial perspective view of the same, and FIG. 14c is a partial cross-sectional view of the same.

FIG. 15 is a partial simplified cross-sectional view showing an example of an input device employing an optical member of an embodiment.

FIG. 16 is an SEM (Scanning Electron Microscope) image photograph showing the shape of the surface of the optical member of Example 1-1 of the invention.

FIG. 17 is an SEM image photograph showing the shape of the surface of the optical member of Example 1-2 of the invention.

FIG. 18 is an SEM image photograph showing the shape of the surface of the optical member of Example 4-1 of the invention.

FIG. 19 is an SEM image photograph showing the shape of the surface of the optical member of Example 4-2 of the invention.

FIG. 20 is an SEM image photograph showing the shape of the surface of the optical member of Example 5-1 of the invention.

FIG. 21 is a graph showing the luminance distribution obtained with an illumination device applying Examples 5-1, 5-2, and 5-3, and Comparative Examples 5-1 and 5-2 onto organic light emitting diodes.

FIG. 22a is front view showing the shape and dimensions of the optical member of Example 5-1 of the invention, and FIG. 22b is a simplified cross-sectional view of the same.

FIG. 23a is front view showing the shape and dimensions of a concavity in the base mold used for Example 6-1 of the invention, and FIG. 23b is a simplified cross-sectional view of the same.

FIG. 24 is an SEM image photograph showing the shape of the surface of the optical member of Example 6-1 of the invention.

FIG. 25a is a partial cross-sectional view showing an example of microlens sheeting used for forming a three-dimensional composite image as a result of applying an optical member according to an embodiment of the invention.

FIG. 25b is a partial cross-sectional view showing an example of microlens sheeting used for forming a three-dimensional composite image as a result of applying an optical member according to this embodiment.

FIG. 26 is a conceptual view of the microlens sheeting of this embodiment, including a composite image that floats above the sheeting under transmitted light.

FIG. 27a is cross-sectional view showing the shape of a base mold used in Example 8, and FIG. 27b is a front view of the same.

FIGS. 28a to 28c are views showing a coating process using the base mold of Example 8.

FIG. 29 is a conceptual view of process for drawing a composite image in microlens sheeting of Example 8.

FIG. 30a is a photograph showing the floating composite image formed by a microlens sheeting without protective material, and FIG. 30b is a photograph showing the floating composite image formed by a microlens sheeting with protective material.

### DETAILED DESCRIPTION OF THE INVENTION

The optical member according to an embodiment of the present invention (hereinafter referred to as “optical member of this embodiment”) is an optical member having a microlens array formed using a replication process that employs a mold comprising a plurality of gas bubbles arranged on a replication surface. By actively using the gas bubbles as part of the mold, it is possible to obtain, using a simple process, lenses having smooth curved surfaces with low distortion that have been difficult to obtain by methods such as mechanical polishing.

Throughout the present specification, the term “microlens” refers to a lens with a diameter of no greater than about 10 mm, and typically between about 0.1 μm to several mm. The term “lens diameter” means the lens width of the maximum cross-section of a concave lens or convex lens. The “maximum cross-section” is the cross-section at which the lens cross-sectional area is greatest, of all the cross-sections perpendicular to the direction of the main surface of the optical member.

There are no particular restrictions on the gas forming the “gas bubbles”. Using air will simplify the replication process since it can be carried out in air, but an inert gas such as nitrogen or argon may be used instead. The shape of the gas bubbles may be adjusted by the form and material of the concavities of the base mold, and by varying the process conditions, as described below. References to the “base mold” throughout the present specification pertain to the non-gas bubble section of the mold used in a process of trapping gas bubbles onto the replication surface for direct replication of the gas bubble shape (hereinafter, “first replication process”). The “base mold” will sometimes be referred to as the “first mold”.

The “arrangement of gas bubbles” formed on the replication surface refers to the state of gas bubbles arranged on the replication surface with a constant regularity, and it includes any arrangement pattern such as rows, a lattice, zigzag lattice or radial pattern.

The arrangement pattern does not need to be formed consistently across the entire replication surface and may be formed only on part thereof, or a plurality of different arrangement patterns may be used within the same plane. For example, when combined with a lattice-like light-shielding pattern such as a black matrix used in a display device or the like, as described hereunder, the gas bubbles may be replicated to the lattice form together with the light-shielding pattern, allowing formation of a concave lens or convex lens arranged in a lattice-like fashion.

The gas bubbles to be formed on the replication surface need only be present during replication, and the base mold may be integral with the gas bubbles during replication to form the replication surface. The “arrangement of gas bubbles” to be formed on the replication surface will be reflected in the arrangement of the microlens array of the optical member of this embodiment.

The optical member of this embodiment can acquire its arrangement of concave lenses or convex lenses by replication of the gas bubble shape, where “concave lens” or “convex lens” means a lens with a convex section or a lens with a concave section, the various forms the are adoptable by the gas bubbles captured in the replication surface being replicated during replication. It may also have any of various curved surfaces, such as roughly spherical, roughly hemispherical, partially spherical, or spherical with a synthesis of different curvatures.

The optical member of this embodiment may be an optical member with concave lenses or convex lenses of essentially equal shape and size arranged on the main surface in each row, and it may also be an optical member with concave lenses or convex lenses of different shapes and sizes arranged on the same main surface.

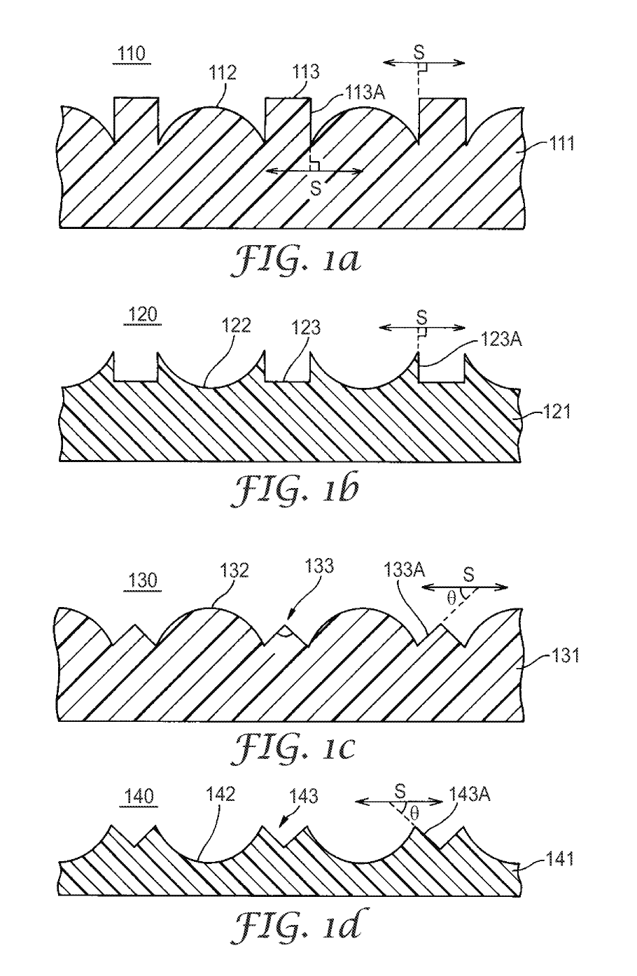

FIG. 1a to FIG. 1d show examples of the cross-sectional shapes of optical members according to this embodiment. The optical member of this embodiment has a shape obtained by inverting a replication surface obtained by direct replication of a replication surface comprising both a base mold with a pattern of concavities and gas bubbles, or a shape obtained by further replicating the surface.

For example, as shown in FIG. 1a or FIG. 1c, the optical member of this embodiment may have a plurality of convex lenses 112, 132 arranged on a main surface and partition walls 113, 133 adjacent to each lens and surrounding each of the convex lenses 112, 132. Alternatively, as shown in FIG. 1b or FIG. 1d, the optical member of this embodiment may have a plurality of concave lenses 122, 142 arranged on a main surface and grooves 123, 143 adjacent to each lens and surrounding each of the concave lenses 122, 142.

The partition walls formed around the convex lenses 112, 132 may have sides 113A that are roughly perpendicular to the main surface direction S of the optical member, as shown in FIG. 1a, or they may have sides 133A that are slanted at less than 90 degrees with respect to the main surface direction S, as shown in FIG. 1c, depending on the type of base mold used. Also, the grooves formed around the concave lenses 122, 142 may have sides 123A that are roughly perpendicular to the main surface direction S of the optical member, as shown in FIG. 1b, or they may have sides 143A that are slanted at less than 90 degrees with respect to the main surface direction S, as shown in FIG. 1d, depending on the type of base mold used.

These optical members can actively utilize the lens function or other functions not only of the convex lenses and concave lenses, but also of the partition wall or groove sections. The optical members 130, 140 shown in FIG. 1c and FIG. 1d, for example, can effectively utilize the partition walls with slanted surfaces as prism lenses. The angle Op between the two adjacent slanted surfaces forming the apex angle of the prism, or the widths of the slanted surfaces, can be easily modified to adjust the optical characteristics of the prism. By combining prisms with the concave lenses or convex lenses, it is possible to widen the adjustable range for the optical characteristics of the optical member of this embodiment. When the surrounding partition walls and grooves are actively used as prisms or the like in addition to the convex lenses or concave lenses, it is possible to exhibit an optical function across almost the entire main surface of the optical member.

The optical member of this embodiment is not particularly restricted so long as it is formed of a material obtained by hardening a hardenable fluid, as explained in the production process described hereunder. For example, a resin, ceramic material or the like may be used. Because the use is as an optical member, it is used as a member that transmits or reflects the light that will ordinarily be used. When it is to transmit the light that is to be used, therefore, it is preferably a material that effectively transmits at least the wavelength of the light that is to be used. This will typically be the visible light range (400 nm to 800 nm), where it preferably has a transmittance of 60% or greater, or 70% or greater. As examples there may be used various synthetic resins such as polyvinyl chloride, fluorine-based resins, polyurethane resins, polyester resins, polyolefin-based resins, acrylic-based resins, methacryl-based resins, silicone resins, epoxy resins and the like, or silicon oxide, titanium oxide or ceramics such as various glass materials.

When used as a member that reflects light impinging on the main surface at the main surface, it is sufficient for the surface to have at least a reflective property, with the optical member being either transparent or opaque, and the optical member surface may further be provided with a reflective layer comprising a metal film, dielectric material multilayer film or organic multilayer film.

The overall shape of the optical member may be any shape that allows replication onto the main surface by a replication process, and a sheet-like, laminar, spherical, cubic, cuboid or other shape may be selected according to the purpose of use. It has at least convex lenses or concave lenses obtained by replication of gas bubble shape onto the main surface, and these are not limited to a single side but may be formed on different sides, with similar lenses being formed on, for example, the main side and back side of the sheet.

When the optical member is in the form of a sheet, it can be easily integrated into the structure of a display device or luminous device since it occupies little space. For example, although the thickness can be adjusted according to the purpose of use, the thickness of a sheet-like optical member may be at least 1 μm, at least 10 μm or at least 50 μm, and no greater than 5 mm, no greater than 2 mm, no greater than 1 mm or no greater than 500 μm. When a flexible material is used as the optical member, it may be deformed as appropriate for the purpose, and laid along a three-dimensional surface with irregularities, or a curved surface.

Since the convex lenses 112, 132 and concave lenses 122, 142 of this embodiment are obtained by replication of gas bubble shape, their surfaces are smooth and, as an example, the surface roughness Ra at the lens center section can be 100 nm or lower, 50 nm or lower, 10 nm or lower or even 5 nm or lower, although this will depend on the material onto which they are replicated.

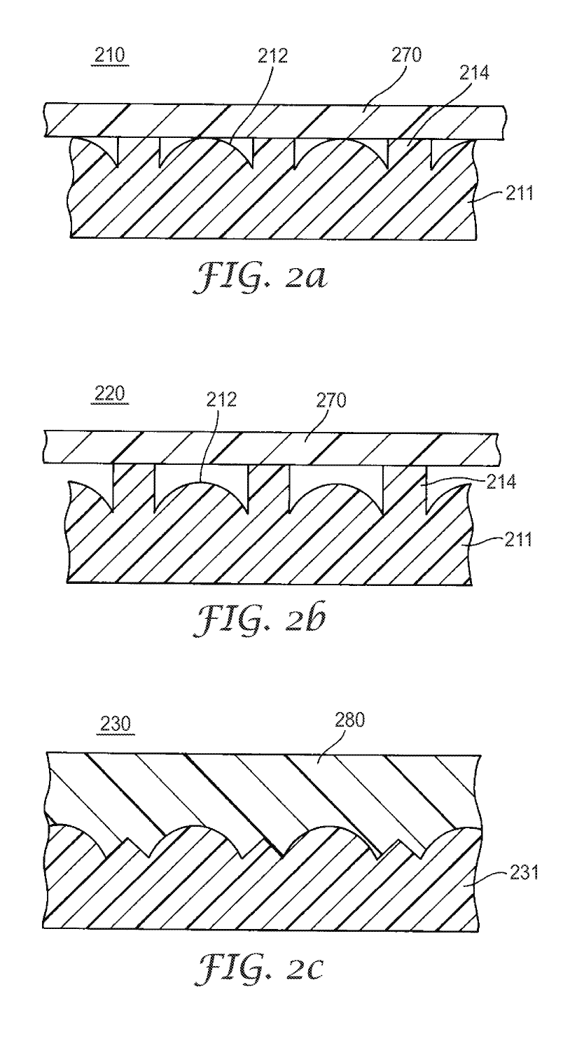

FIGS. 2a to 2c show other embodiments of the optical member for this embodiment.

The optical members 210 and 220 shown in FIG. 2a and FIG. 2b are obtained by laminating a separate member 270, such as a transparent resin base, for example, for protection onto an optical member 211 having convex lenses or concave lenses obtained by replication of gas bubble shape. In this case, the heights of the partition walls 214 formed around each of the convex lenses 212 may be utilized to adjust the distance between the optical member 211 and the other member 270 laminated adjacent to the optical member. That is, as shown in FIG. 2b, the partition walls 214 can be utilized as spacers so that the member 270 contacts with the lens surfaces while maintaining air spaces on the surfaces of the lenses 212 formed on each main surface of the convex lens optical member 211. The member 270 can also anchor the optical member 211 via a pressure-sensitive adhesive material or adhesive.

The optical member 230 shown in FIG. 2c has a covering layer 280 formed on the main surface of the optical member 231 for protection or for adjustment of the optical characteristics. For example, the covering layer 280 may be provided for protection of the optical member 231, in order to adjust the refractive index at the lens interface, in order to adjust the distance between the adjacent member and the lens surface, or in order to provide a reflective layer.

The covering layer 280, when used for protection of the optical member 231 or in order to adjust the refractive index at the lens interface, for example, is preferably a material that effectively transmits at least the wavelength of the light that is to be used, similar to the optical member, and typically it preferably has a transmittance of at least 60% or at least 70% in the visible light range (400 nm to 800 nm). As examples there may be used materials different from the optical member 231, selected from among various synthetic resins such as polyvinyl chloride, fluorine-based resins, polyurethane resins, polyester resins, polyolefin-based resins, acrylic-based resins, methacryl-based resins, silicone resins, epoxy resins and the like, or silicon oxide, titanium oxide or ceramics such as various glass materials, according to the purpose of use.

When the covering layer 280 is used for the purpose of providing a reflective layer to the optical member 231, a metal film, dielectric multilayer film or the like may be used.

The method for forming the covering layer 280 may be the coating process used for production of the optical member described hereunder, or any of various other types of processes such as dip coating, spray coating, vapor deposition, sputtering and the like. As explained below, the mold used in the replication process may also be used as the covering layer 280 if the mold is left instead of being removed. There are no restrictions on the thickness of the covering layer, and it may be from several nm to about 1 mm, according to the purpose of use.

A specific mode and shape of the optical member of this embodiment will now be explained in the context of the production process. The uses of the optical member, and specific embodiments of the optical member suitable for the uses, will also be explained below.

The optical member of this embodiment is primarily characterized in that a concave or convex microlens array is formed using a replication process employing a mold having gas bubbles arranged on a replication surface. Specifically, a first replication process comprises, generally, (1) a step in which a base mold (also referred to as “first mold”) having a mold surface with an arrangement pattern is prepared, (2) a step in which a hardenable fluid is supplied onto the mold surface in such a manner that gas bubbles are trapped in each arrangement pattern, (3) a step in which the hardenable fluid is hardened, and (4) a step in which the obtained hardened layer is removed from the base mold.

The steps in a process for producing the optical member of this embodiment will now be explained with reference to FIG. 3a to FIG. 6g. First, the first replication process for this embodiment will be described in general terms. For convenience in explanation, steps using two different base molds with different concavity shapes will both be explained.

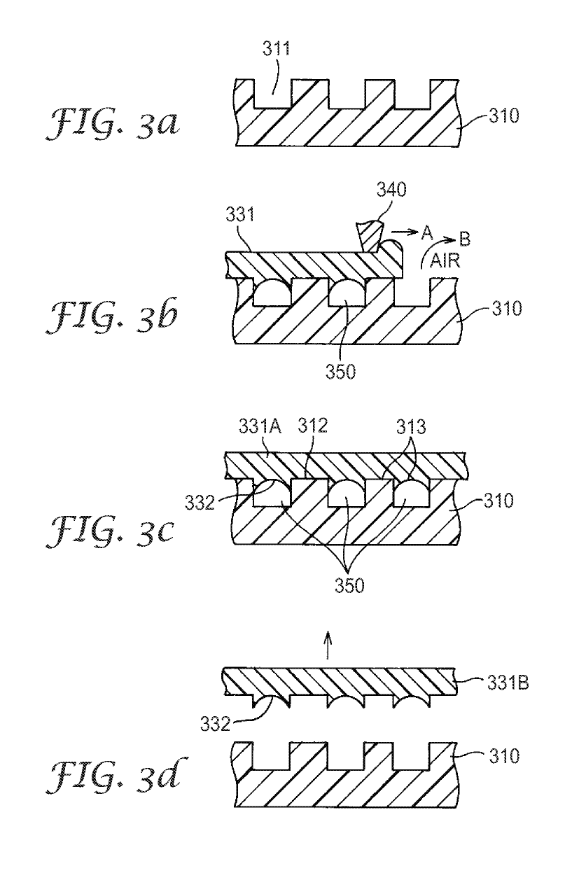

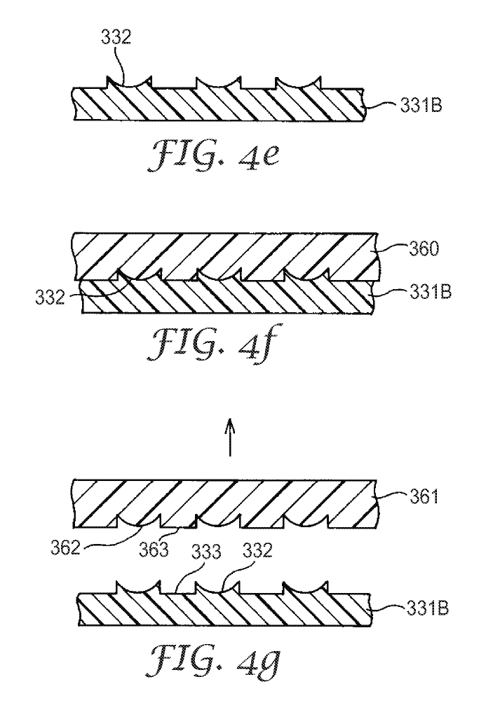

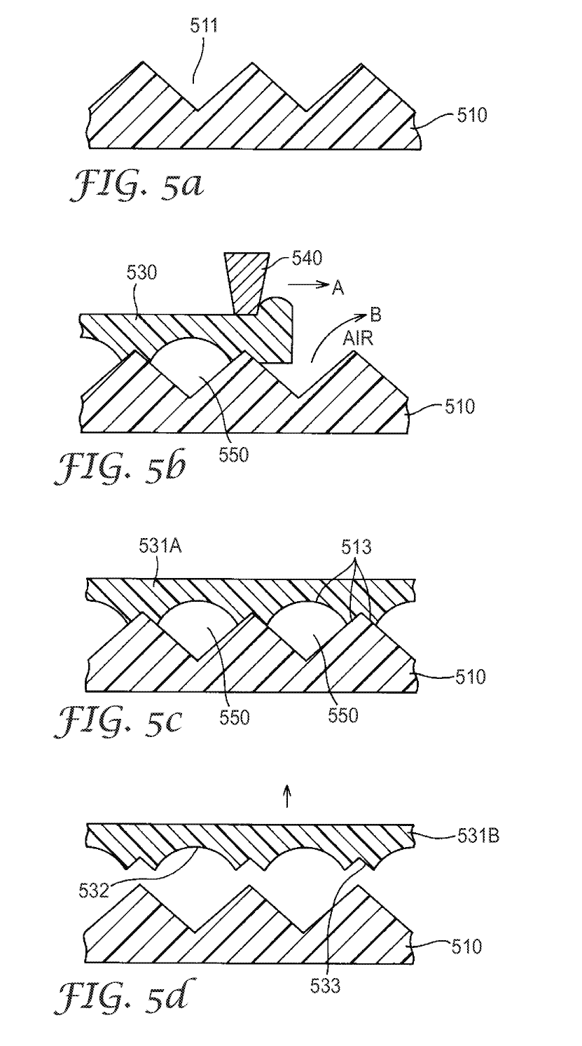

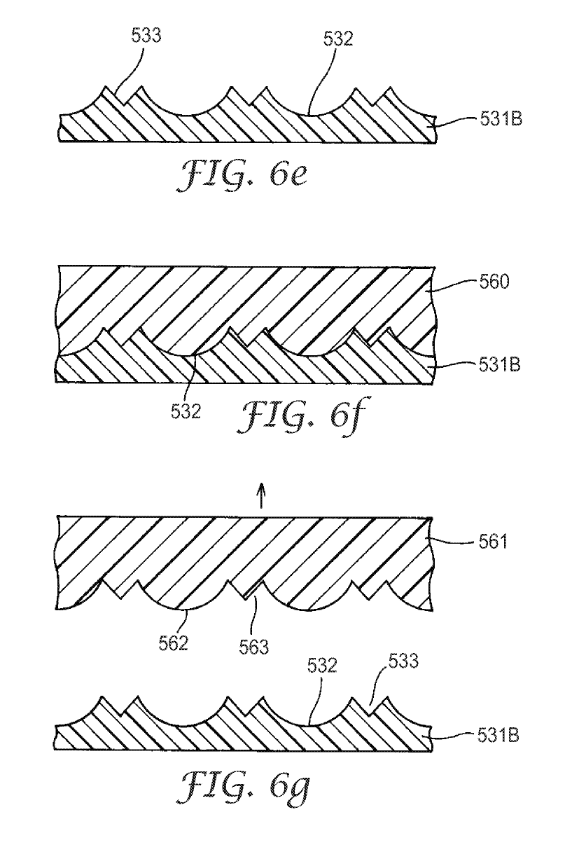

In the first replication process for this embodiment, first base molds 310, 510 having mold surfaces with arrangement patterns are prepared (see FIG. 3a, FIG. 5a). FIGS. 3a to 3d and FIGS. 4e to 4g show examples of steps employing a base mold 310 with columnar or cylindrical concavities 311, and FIGS. 5a to 5d and FIGS. 6e to 6g show examples of steps employing a base mold 510 with pyramidal or conical shaped concavities 511. Next, the hardenable fluid 330, 530 is coated onto the mold surface in such a manner that gas bubbles 350, 550 are trapped in the concavities 311, 511 of the base mold 310, 510 (see FIG. 3b, FIG. 5b). The hardenable fluid 330, 530 is then hardened (see FIG. 3c, FIG. 5c) to obtain a hardened layer 331A, 531A. Next, the hardened layer 331A, 531A, onto which the gas bubbles and the mold surface of the base mold have been replicated from the base mold 310, 510, is removed (released) as a structure 331B, 531B (see FIG. 3d, FIG. 5d). The structure 331B, 531B removed from the base mold 310, 510 may be used as an optical member whose main surface comprises multiple concave lenses and grooves formed around the concave lenses.

When forming an optical member of this embodiment with convex lenses, the replication process shown in FIGS. 4e to 4g or FIGS. 6e to 6g (“second replication process”) is further carried out. That is, the structure 331B, 531B obtained in the step described above is used as the second mold (see FIG. 4e, FIG. 6e), and the hardenable fluid 360, 560 is coated onto the replication surface (see FIG. 4f, FIG. 6f) and hardened. Next, the hardened structure 361, 561 is removed from the second mold (structure 331B, 531B) (see FIG. 4g, FIG. 6g). An ordinary existing replication process may be used for the series of steps in the second replication process, and gas bubbles are not included in the replication surface. Thus, the removed structure 361, 561 may be used as an optical member having multiple convex lenses arranged on the main surface, and partition walls adjacent to each convex lens and surrounding each convex lens. It may also be used as an optical member in its laminated form, without removing the structure 361, 561 from the second mold (structure 331B, 531B).

In the first replication process of this embodiment, the gas bubbles tend to form spherical convex curved surfaces of minimal interfacial area in the regions where the gas bubbles and hardenable fluid supplied to the mold surface of the base mold are in contact, in order to minimize the interfacial energy between them and the hardenable fluid. In actuality, the gas bubbles are affected by other parameters such as buoyancy, gravity and the viscosity of the hardenable fluid, and also by interfacial tension between the gas bubbles and mold surface or interfacial tension between the hardenable fluid and mold surface, near the regions where the gas bubbles contact the surface of the base mold. However, when essentially uniform force is applied to the convex curved surfaces of the gas bubbles, or essentially symmetrical force is applied to the apexes of the convex curved surfaces, the gas bubbles can form evenly smooth curved surfaces without deformation into warped shapes. Consequently, concave lenses obtained using a replication surface containing gas bubbles obtained by the first replication process of this embodiment are able to adopt the smooth concave curved surfaces which are the inverse of the outer shapes of the gas bubbles. Convex lenses obtained by the second replication process upon replication of the concave curved surface shape can also adopt smooth convex curved surface.

According to this embodiment, replication of shape of the gas bubbles arranged on the replication surface onto the hardenable fluid allows a simple process to be used to produce a microlens array, which has conventionally required formation through a complex process with a long operating time. The replication process employing gas bubbles according to this embodiment can also be easily applied to large-area devices, such as for formation of, for example, 1 m×1 m large optical members. In the first replication process of this embodiment, gas bubbles are actively and deliberately trapped for use of the gas bubbles as part of the replication surface. This differs, therefore, from ordinary replication processes in which replication is accomplished without gas bubbles or, if gas bubbles are included, degassing is carried out by reduced pressure. When the gas bubbles are incorporated from the surrounding gas such as air in the first replication process of this embodiment, the process may be carried out in air, thus allowing fabrication with very simple production equipment that does not need special apparatuses such as vacuum chambers.

The second replication process in which the optical member comprising convex lenses is produced may employ an ordinary replication process, but there are no particular restrictions on the specific method of replication. There may also be employed the same replication method as the first replication process but using an ultraviolet curing resin, thermosetting resin or two-solution ordinary temperature curable resin or the like, or a replication method that employs a hot press with a thermoplastic resin, or electroforming.

The structure obtained by the second replication process may further be used as the third mold in a third replication process. The replication process following the second replication process may be an ordinary replication process, and these processes may also be repeated several times. In addition, a mold with concave curved surfaces obtained by the series of steps in this replication process and a mold with convex curved surfaces obtained by replicating the same may be used as stampers to produce multiple optical members. An optical member obtained by any of these processes corresponds to the optical member of this embodiment, fabricated by a replication process utilizing gas bubbles according to this embodiment.

By the aforementioned replication process that employs gas bubbles, it is possible to easily obtain an optical member having a microlens array pattern with a plurality of fine convex lenses or concave lenses. It is also easy to produce large-area versions of the optical member of this embodiment by the aforementioned replication process.

Furthermore, since the optical member of this embodiment is provided with an arrangement pattern integrating the base mold surface and gas bubbles on the main surface, it is possible to impart to the main surface of the optical member the partition walls or grooves corresponding to the base mold surface, around the lens sections to which the gas bubbles have been replicated.

The steps in a process for producing the optical member of this embodiment will now be explained in greater detail, with reference to the same drawings.

In the first replication process of the production process for the optical member of this embodiment, first a base mold is prepared comprising a mold surface provided with an arrangement pattern, as shown in FIG. 3a and FIG. 5a. In this step, a base mold 310, 510 is prepared comprising a mold surface with a plurality of concavities 311, 511 arranged in a prescribed pattern. The arrangement pattern of the base mold corresponds to the arrangement of convex lenses or concave lenses to be obtained in the optical member. If no gas bubbles are present, the “mold surface” of the base mold is the replication surface of the base mold itself If no gas bubbles are present during replication, the shape of the mold surface is replicated to the replication target. According to this embodiment, gas bubbles are trapped in the concavities forming the mold surface when the hardenable fluid is coated on the mold surface, thus forming a replication surface integrally comprising the mold surface and gas bubbles. The shape of the replication surface can be replicated to the optical member. In other words, the replication surface of the mold is formed essentially of the base mold surface and gas bubbles, and this is replicated to the main surface of the optical member of this embodiment.

By providing the concavities in a high precision arrangement on the base mold surface beforehand for this embodiment, it is possible to obtain an optical member having concave lenses with a highly precise arrangement. Also, by forming concavities with prescribed shapes and sizes in the surface of the base mold, it is possible to adjust the sizes and shapes of the trapped gas bubbles. Furthermore, by using a base mold having concavities of the same size and shape arranged thereon, it is possible to capture gas to essentially the same size and shape in each concavity, thereby obtaining concave lenses with essentially the same sizes and shapes.

As already explained, the arrangement pattern of the arranged concavities of this embodiment may be any desired arrangement pattern such as a row, a rectangular lattice, a zigzag lattice or a radial pattern. It may be selected based on the arrangement pattern of the lens that is to provided in the final optical member.

The material for the base mold 310, 510 may be, typically, a resin material, although there is no restriction thereto and any desired organic material, any desired inorganic material such as metal, glass or ceramic, or any desired organic/inorganic composite material, may be used. The dimensions of the base mold 310, 510 may be as desired depending on the size of the coating apparatus, and for example, a lengthwise dimension of from 1 mm to several 1000 mm, a widthwise dimension of from 1 mm to several 1000 mm, and a thickness dimension of from 10 μm to several tens of mm may be mentioned.

The form of the surface of the base mold 310, 510 may be any of various forms, and for example, there may be used a base mold 310 with columnar or cylindrical concavities 311 having rectangular cross-sections, as shown in FIG. 3a, or a base mold 510 with pyramidal or conical concavities having triangular cross-sections, that is slanted surface sides, as shown in FIG. 5a.

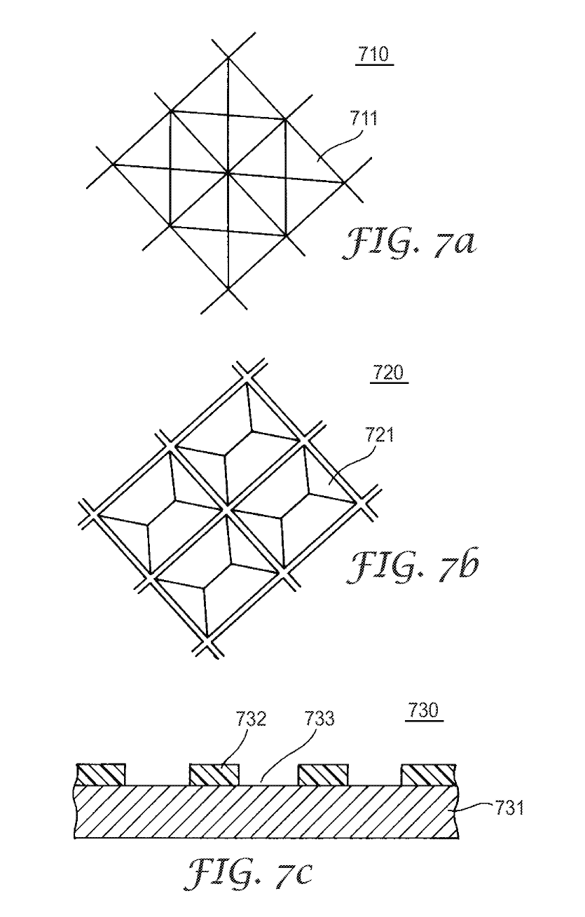

FIGS. 7a to 7c are a set of partial plan views showing examples of shapes for the base mold to be used for this embodiment. The examples are a base mold 710 having square pyramidal concavities 711 as shown in FIG. 7a, and a base mold 720 provided with concavities 721 of a shape having square cones extending in one direction parallel to one side of the base and ridges at the bottom sections of the concavities, as shown in FIG. 7b. The shape of the concavities is not restricted, and any base mold with concavity shapes that can be easily formed by polishing or the like may be used.

As an example of the sizes of concavities that can be formed on the mold surface of the base mold 310, 510, there may be mentioned a depth of between 0.1 μm and several tens of mm, and an opening area of between 0.01 μm² and several 100 mm², although there is no limitation to this example.

The shapes of the concavities 311, 511 of the base mold 310, 510 will reflect the shapes of the partition walls or grooves surrounding the convex lenses or concave lenses of the optical member which is to be obtained as the final product. When the partition walls or grooves surrounding the convex lenses or concave lenses have slanted surfaces, the partition walls formed around convex lenses may also be used as prisms. By adjusting the inclination angle of the walls of the concavities it is possible to change the apex angles of the prisms.

Next, as shown in FIG. 3b and FIG. 5b, the base mold 310, 510 is set in a coating apparatus and the hardenable fluid 330, 530 is coated onto the surface of the base mold 310, 510, while part of the surrounding gas, such as air, is simultaneously trapped in the concavities 311, 511 of the base mold 310, 510.

There are no restrictions on the method for coating the fluid onto the mold surface, and a suitable coating method may be selected according to the type of hardenable fluid, and the shape and size of the structure.

The coating apparatus used may be a knife coater, as a typical example, but there is no restriction thereto and various other types of coating apparatuses may be used such as bar coaters, blade coaters, roll coaters and the like. When a thermoplastic resin is used as the hardenable fluid, a heat knife coater may be used for heating to a temperature that gives the resin a sufficient flow property.

When a knife coater is used for this embodiment, the hardenable fluid is supplied to one edge of the base mold surface, and then a blade 340, 540 having its edge anchored at a fixed height is moved to press out the hardenable fluid over the entire surface of the base mold. That is, by moving the blade 340, 540 at a constant speed in the direction of the arrow A (left to right in the drawings) for this embodiment, the hardenable fluid is coated onto the surface of the base mold 310, 510. During this time, a portion of the surrounding gas is trapped as a gas bubble 350, 550 in the concavity 311, 511 of the base mold 310, 510, as indicated by the arrow B.

The trapped gas bubble 350, 550 integrates with the surface of the base mold 310, 510 to form the replication surface, while the replication surface becomes covered by the coating layer of the hardenable fluid 331, 531. The thickness of the coating layer may be, for example, from 10 μm to several tens of mm or 50 μm-1000 μm, but this is not restrictive and any other thickness may be established according to the purpose of use. When a knife coater is used, the thickness can be adjusted by modifying the gap between the base mold surface and the knife edge.

As explained below, the condition of the trapped gas bubbles depends on various conditions including the viscosity of the hardenable fluid and the wettability of the base mold surface, but the concavities 311, 511 on the surface of the base mold 310, 510 preferably have shapes that can create closed spaces during coating of the hardenable fluid, that is that make it difficult for gas remaining in the concavities 311, 511 to escape. As examples of such concavities there may be mentioned pyramidal shapes such as triangular pyramids, quadrangular pyramids, pentagonal pyramids, hexagonal pyramids, octagonal pyramids and the like, or truncated pyramids, columnar such as triangular columnar, quadrangular columnar, pentagonal columnar, hexagonal columnar, octagonal columnar and the like, as well as circular columnar, circular conic, truncated circular conic or spherical, or shapes that are combinations or partially modified forms of these. These can easily trap gas bubbles because it is difficult for the gas bubbles to escape during coating of the hardenable fluid. In the case of truncated pyramidal concavities, gas bubbles can be easily trapped if the aspect ratio (L/D) between the maximum diameter (Lm) of the opening and the depth (D) is no greater than 20, no greater than 10 or no greater than 5.

The sizes and positions of the trapped gas bubbles will be controlled to some extent by the arrangement, shapes and sizes of the concavities on the surface of the base mold that is used, but they can also be controlled by adjusting various other parameters such as the material of the base mold, the coating speed, and the moving speed of the blade 340, 540. This will be more fully explained below.

The hardenable fluid 330, 530 is a fluid with a flow property allowing it to coat the mold surface when supplied to the base mold, and any hardenable fluid may be used regardless of the hardening method. For example, any gel or liquid organic material, inorganic material or organic/inorganic composite material may be used as the fluid. A photocuring resin, or a liquid resin such as an aqueous solution of a water-soluble resin or a solution of a resin in a solvent, may be used, and if the base mold 310, 510 has sufficient heat resistance, a thermoplastic resin or thermosetting resin may also be used. When an inorganic material is used as the hardenable fluid, it may be any of various inorganic materials such as glass, concrete, gypsum, cement, mortar, ceramic, clay or metal. Organic/inorganic composite materials that are combinations of these organic materials and inorganic materials may also be used.

As ultraviolet curing resins there may be used acrylate-based, methacrylate-based and epoxy-based photopolymerizable monomers containing photopolymerization initiators, or acrylate-based, methacrylate-based, urethane acrylate-based, epoxy-based, epoxy acrylate-based and ester acrylate-based photopolymerizable oligomers. If an ultraviolet curing resin is used, it will be possible to harden the resin in a short period of time without exposing the mold to high temperature.

Examples of thermosetting resins include acrylate-based, methacrylate-based, epoxy-based, phenol-based, melamine-based, urea-based, unsaturated ester-based, alkyd-based, urethane-based and ebonite resins containing thermopolymerization initiators. When using a phenol-based, melamine-based, urea-based, unsaturated ester-based, alkyd-based, urethane-based or ebonite resin, for example, it is possible to obtain a tough molded article with excellent heat resistance and solvent resistance with inclusion of a filler.

As examples of soluble resins there may be mentioned water-soluble polymers such as polyvinyl alcohol, polyacrylic acid-based polymer, polyacrylamide and polyethylene oxide. When using a soluble resin, for example, the density (viscosity) and the surface tension of the soluble resin solution for the coating layer varies in stages during the step of removing the solvent by drying, and therefore a structure with low curvature of the concave curved surface can be obtained.

If a soluble resin is used for the base mold or for the second mold described hereunder, it will be possible to remove (release) these molds by dissolution, without damaging the hardened layer 331A, 531A.

Examples of thermoplastic resins include polyolefin-based resins, polystyrene-based resins, polyvinyl chloride-based resins, polyamide-based resins, polyester-based resins and the like.

Various additives such as thickeners, curing agents, crosslinking agents, initiators, antioxidants, antistatic agents, surfactants, pigments, dyes and the like may be added to any of these resins. However, the resin material used for this embodiment is not limited to the materials mentioned as examples above, and any other resins may be used alone or in combination.

Next, as shown in FIG. 3c and FIG. 5c, the coating layer of the hardenable fluid 330, 530, having gas bubbles 350, 550 trapped in the concavities 311, 511 of the base mold 310, 510, is hardened to form a hardened layer 331A, 531A.

If an ultraviolet curing resin is used as the hardenable fluid 330, 530 it will be possible to form the hardened layer 331A, 531A by irradiating the coating layer with ultraviolet rays to polymerize the resin. If the hardenable fluid is a soluble resin, it will be possible to form the hardened layer 331A, 531A by removing the solvent by drying. Also, if the hardenable fluid is a thermoplastic resin, it will be possible to form the hardened layer 331A, 531A by cooling the resin to below its curing temperature. If the hardenable fluid is a thermosetting resin it will be possible to form the hardened layer 331A, 531A by heating the resin to above its curing temperature. A hardened layer 331A, 531A is thus formed having the form of the replicated replication surface comprising gas bubbles 350 and the surface of the base mold 310, or in other words, having a plurality of fine concave curved surfaces and grooves surrounding them arranged on the main surface.

Next, as shown in FIG. 3d and FIG. 5d, the hardened layer 331A, 531A is removed from the base mold 310, 510. The removed structure 331B, 531B may be used as an optical member having a microlens array with an arrangement of multiple concave lenses, or it may be used as a second replication process mold (“second mold”) for production of an optical member having a microlens array with an arrangement of multiple convex lenses, as shown by FIGS. 3e to 3g or FIGS. 5e to 5g.

As mentioned above, the replication surface in the first replication process used for this embodiment comprises a base mold 310, 510 and gas bubbles 350, 550. The sizes and shape of the gas bubbles 350, 550 trapped in each concavity of the base mold 310, 510 are determined by parameters such as interfacial tension between the gas bubbles and hardenable fluid, buoyancy, gravity, interfacial tension between the gas bubbles and base mold surface, and interfacial tension between the hardenable fluid and base mold surface.

In the first replication process for this embodiment, the gas bubbles are used as part of the mold to obtain, without special working, a replication surface with essentially spherical convexities that have required molding with a long operating time in the prior art. In particular, it is possible to obtain a convex curved surface having a smooth surface without distortion that is necessary for formation of fine concave lenses, without requiring special micromachining

The optical member obtained in this manner has an arrangement pattern with multiple concave lenses 122, 142 surrounded by grooves 123, 143 on the main surface, as shown in FIG. 1b and FIG. 1d. The shapes of the grooves 123, 143 may be any of various shapes suitable for the concave shape of the base mold 310, 510, and if the grooves are slanted with respect to the main surface direction S as shown in FIG. 1d, it may be used as a reflection surface or refraction surface. That is, the groove sections may be used, not only as concave lens sections, but also as sections with an optical function such as prisms.

The optical member (structure 331B, 531B) obtained by the first replication process described above possesses a surface replicated from the replication surface comprising the concavity arrangement pattern and gas bubbles 350, 550 of the base mold 310, 510, and the concave curved surfaces 332, 532 resulting from replication of the gas bubbles 350, 550 are curved surfaces corresponding to the shapes and sizes of the gas bubbles 350, 550. The resulting curved surface may form a curve which is part of essentially a sphere, or it may assume a curved surface deformed by the conditions of placement of the gas bubbles, but the sizes and shape of the gas bubbles can be adjusted by the shapes and sizes of the concavities 311, 511 in the base mold 310, 510.

The dimensions of the obtained concave curved surface 332, 532 may be, for example, at least 0.01 μm² or at least 1 μm² and no greater than 100 mm² or no greater than 10 mm², as the area of the base section, and a height dimension of at least 0.1 μm or at least 10 μm and no greater than several tens of mm or no greater than 1 mm. However there is no limitation to these ranges, and the dimensions may be as desired according to the purpose of use.

The sizes, shapes and positions of the gas bubbles may be controlled according to the purpose of use of the optical member of this embodiment. Some uses will not require strict precision of shape or size, while others may require improved performance of the optical member by increased precision. A method for controlling the sizes, shapes and positions of the trapped gas bubbles in the replication process using the gas bubbles will now be explained. Controlling the sizes, shapes and positions of the gas bubbles allows control of the sizes, shapes and positions of the concave lenses 332, 532 of the optical member (structure 331B, 531B). Also, when the structure 331B, 531B is used as a second mold in the second replication process described below, this will allow control of the sizes, shapes and positions of the curved surfaces of the convex lenses of the optical member (structure 361, 561).

The shapes and sizes of the gas bubbles 350, 550 may be controlled by adjusting, for example, (a) the sizes and shapes of the concavities in the base mold, (b) the viscosity of the hardenable fluid added to the base mold, (c) the coating speed of the hardenable fluid onto the base mold, (d) the coating pressure of the hardenable fluid on the base mold, (e) the interfacial tension between the hardenable fluid, base mold and gas bubbles, (f) the time from coating of the hardenable fluid until hardening, (g) the temperature of the gas bubbles and (h) the pressure of the gas bubbles.

First, the gas bubbles 350, 550 can be adjusted primarily by the sizes and shapes of the concavities 311, 511 in the base mold. The gas bubbles 350, 550 are disposed in contact with the mold surface of the concavities 311, 511 and are significantly affected by interfacial tension between the gas bubbles 350, 550 and hardenable fluid at the interface with the hardenable fluid 330, 530, forming convex curved surfaces. Near the regions of the concavities 311, 511 that contact the mold surface, on the other hand, there are also effects of interfacial tension between the gas bubbles 350, 550 and the mold surface of the concavities 311, 511 and interfacial tension between the hardenable fluid 330, 530 and the mold surface of the concavities 311, 511. Thus, the gas bubbles 350, 550 form smooth convex curved surfaces in the regions in contact with the hardenable fluid, and the curvature and shapes of the convex curved surfaces can be adjusted by the sizes and shapes of the concavities 311, 511.

The two-dimensional configuration of the concavities 311, 511 may have various different forms, but if a symmetrical form (point symmetry or line symmetry), or an approximation thereof, is used for the two-dimensional configuration of the concavities 311, 511, it will be possible obtain gas bubbles 350, 550 having convex curved surfaces with good symmetry and low aberration. That is, since each of the apexes of the convex curved surfaces of the gas bubbles are disposed at the center of a roughly symmetrical two-dimensional configuration, it is possible to obtain distortion-free, smooth convex curved surfaces suitable for lenses.

For example, the concavities 711 of the base mold 710 shown in FIG. 7a are examples of a two-dimensional configuration with point symmetry, and the concavities 720 of the base mold 720 shown in FIG. 7b are examples of line symmetry.

The base mold is not limited to a single layer and may be, instead, a structure with multiple layers as shown in FIG. 7c. For example, a resin layer 732 laminated on a metal sheet 731 may be used, and openings (concavities) 733 formed by laser working or the like only on the resin layer. Alternatively, a photolithographic process may be used for selective etching only on one layer of a laminated sheet with a two-layer structure, to form an arrangement of openings (concavities). This method allows easy formation of a concavity pattern with the prescribed arrangement.

Since the buoyancy and gravity of the convex curved surfaces of the gas bubbles can be kept constant by setting the base mold 310, 510 horizontally or by using the symmetry of the two-dimensional configuration of concavities in the base mold, the gas bubbles can adopt essentially spherical convex curved surfaces, but even if the base mold is not placed horizontally, if it is set on a slanted surface or if the two-dimensional configuration of the concavities in the base mold used have an asymmetrical form, the shapes of the gas bubbles can be altered to adjust the optical characteristics of the optical member.

Depending on the purpose, the concavities formed in the surface of the base mold may also have different shapes and sizes, instead of a single shape, on the same mold surface. Also depending on the purpose, different arrangement patterns may be formed on the same mold surface.

The sizes and shapes of the gas bubbles 350, 550 can be controlled by adjusting the viscosity of the hardenable fluid 330, 530 coated onto the base mold 310, 510. Specifically, the viscosity of the hardenable fluid 330, 530 may be increased to produce larger gas bubbles 350, 550, or the viscosity of the hardenable fluid 330, 530 may be decreased to produce smaller gas bubbles 350,550. There are no particular restrictions on the viscosity of the hardenable fluid, and it may be at least 1 mPas, at least 10 mPas, or at least 100 mPas, for example. It may also be, for example, no greater than 100,000 mPas, no greater than 10,000 mPas or no greater than 1000 mPas. The viscosity can be adjusted by modifying the concentration of the hardenable fluid, or by adding a thickener.

The sizes and shapes of the gas bubbles 350, 550 can also be controlled by varying the coating speed of the hardenable fluid onto the base mold 310, 510, that is by varying the traveling speed of the blade 340, 540 indicated by the arrow A in FIG. 3b and FIG. 5b. Specifically, the coating speed may be increased to produce larger gas bubbles 350, 550, or the coating speed may be decreased to produce smaller gas bubbles 350, 550.

The adjustable range for the coating speed may be, for example, 0.01 cm/sec-1000 cm/sec, 0.5 cm/sec-100 cm/sec, 0.5 cm/sec-100 cm/sec, 1 cm/sec-50 cm/sec or 1 cm/sec-25 cm/sec, although there is no limitation to these ranges. When the coating apparatus is provided with a head that supplies the hardenable fluid, the coating speed can be adjusted by the head movement speed, or when the coating apparatus is a spin coater it can be adjusted by the rotational speed.

As an example, if the coating speed is faster than the speed at which the hardenable fluid naturally falls into the concavities in the surface of the base mold, the gas bubbles will be trapped more easily in the concavities. The speed at which the hardenable fluid naturally falls is the speed at which it naturally flows when placed in the concavities of the mold surface, and this is affected by the viscosity of the hardenable fluid or the interfacial tension between the hardenable fluid, gas bubbles and mold surface. For example, if the viscosity of the hardenable fluid is very low, the coating speed may be increased or the material of the base mold surface changed to allow gas bubbles to be trapped in the concavities.

The sizes and shapes of the gas bubbles 350, 550 can also be controlled by adjusting the interfacial tension between the hardenable fluid 330, 530 and the surface of the base mold 310, 510, the interfacial tension between the hardenable fluid and the gas bubbles 350, 550 or the interfacial tension between the gas bubbles 350, 550 and the surface of the base mold 310, 510 in the step shown in FIG. 3b or FIG. 5b, to control the sizes of the trapped gas bubbles 350, 550.

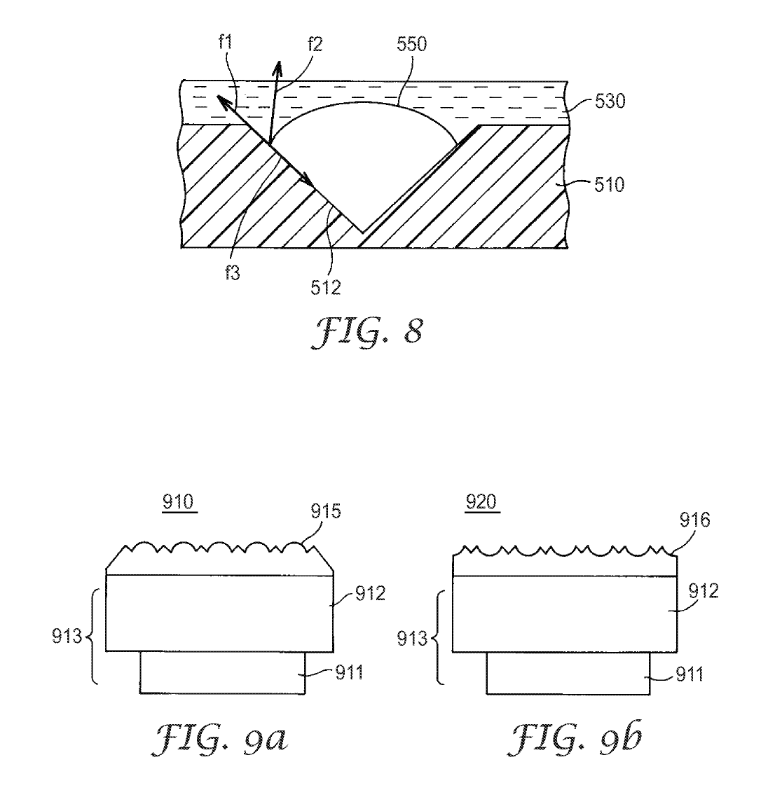

FIG. 8 is a partial cross-sectional view of the step illustrated in FIG. 5b. Trapping of the gas bubbles 350, 550 and the shapes and sizes of the trapped gas bubbles are affected by the interfacial tension f1 between the hardenable fluid 530 and the surface of the base mold 510, the interfacial tension f2 between the hardenable fluid 530 and the gas bubbles 550 and the interfacial tension f3 between the gas bubbles 550 and the surface of the base mold 510, as shown in the cross-sectional view of FIG. 8, as well as by gravity, buoyancy, temperature and pressure. Of these factors, adjustment of the interfacial tension f1 between the hardenable fluid 530 and the surface of the base mold 510 allows control of the trapped state of the gas bubbles 550, such as the positions of the gas bubbles in the concavities, thus allowing control of the shapes and sizes of the gas bubbles 550.

Specifically, for example, by increasing the contact angle (lowering the wettability) between the hardenable fluid 530 and the surface of the base mold 310, 510, it is possible to increase the size of the gas bubbles 350, 550, and by decreasing the contact angle (raising the wettability) between the hardenable fluid 530 and the surface of the base mold 310, 510, it is possible to reduce the size of the gas bubbles 350, 550.

As an example, if the contact angle of a droplet of fluid obtained by interfacial tension is no larger than 70 degrees or no larger than 60 degrees when the hardenable fluid is dropped onto a plate made of the same material as the base mold 510, gas bubbles will be trapped in the concavities 311, 511 of the base mold 310, 510 during the step illustrated in FIG. 3b or FIG. 5b, while the gas bubbles can be increased in size with a larger contact angle. Incidentally, because these conditions are affected by the shapes of the concavities in the base mold as well as other conditions, it is still possible to trap gas bubbles even with a contact angle of 60 degrees or larger or 70 degrees or larger, if the conditions are modified.

For example, if a polyester-based urethane acrylate, which is an ultraviolet curing resin, is used as the hardenable fluid 330, 530, and a resin such as silicone resin, polypropylene, polystyrene, polyethylene, polycarbonate or polymethyl methacrylate or a metal material such as nickel is used as the base mold 310, 510, gas bubbles can be trapped with the contact angles described above.

The contact angle between the hardenable fluid 330, 530 and the surface of the base mold 310, 510 can also be adjusted by treating the surface of the base mold. For example, the contact angle can be modified by surface treatment with a liquid or plasma treatment, or treatment by another method.

Surface treatment with a liquid may be accomplished, for example, by treatment of the mold surface with a fluorine-based surface treatment agent. As an example, the surface of a resin base mold made of polyester, polystyrene, polypropylene, polycarbonate, ABS (acrylonitrile, butadiene and styrene copolymer) or the like may be subjected to surface treatment with the fluorine-based surface treatment agent Novec™ EGC-1720 by 3M Corp., to increase the contact angle between the hardenable fluid and mold surface and lower the wettability. This will increase the sizes of the gas bubbles as a result.

For plasma treatment, a commercially available plasma treatment apparatus may be used and the type of gas and output conditions adjusted to modify the contact angle between the hardenable fluid and mold surface. As an example, a fluorine-based gas such as C₃F₈ may be used for treatment of a nickel base mold surface, to increase the contact angle between the hardenable fluid and mold surface and lower the wettability. This will increase the sizes of the gas bubbles as a result. The surface of a base mold may also be treated using a mixed gas of tetramethylsilane (TMS) and oxygen (O₂) to decrease the contact angle between the hardenable fluid and mold surface and raise the wettability. This will decrease the sizes of the gas bubbles as a result.

The sizes and shapes of the gas bubbles 350, 550 can also be controlled by adjusting the time until the coated hardenable fluid 330, 530 hardens in the step illustrated in FIG. 3c or FIG. 5c. Specifically, for example, the time from coating to hardening may be shortened to increase the sizes of the gas bubbles 350, 550, or the time from coating to hardening may be lengthened to decrease the sizes of the gas bubbles 350, 550.

The sizes and shapes of the gas bubbles 350, 550 can also be controlled by adjusting the temperature of the gas bubbles after the hardenable fluid 330, 530 is coated onto the base mold 310, 510 and before it hardens, or during the hardening, in the step illustrated in FIG. 3b-c or FIG. 5b-c, to control the sizes of the trapped gas bubbles 350, 550. Specifically, for example, the temperature of the gas bubbles may be raised to increase the sizes of the gas bubbles 350, 550, or the temperature of the gas bubbles may be lowered to decrease the sizes of the gas bubbles 350, 550. Adjustment of the temperature of the gas bubbles 350, 550 is one method of control that allows the sizes of the gas bubbles 350, 550 to be modified after the gas bubbles 350, 550 have already been trapped.

In addition, the sizes and shapes of the gas bubbles 350, 550 can be controlled by adjusting the pressure on the gas bubbles after the hardenable fluid 330, 530 is coated onto the base mold 310, 510 and before it hardens, or during the hardening, in the step illustrated in FIG. 3b-c or FIG. 5b-c, to control the sizes of the trapped gas bubbles 350, 550. Specifically, for example, the pressure on the gas bubbles may be lowered to increase the sizes of the gas bubbles 350, 550, or the pressure on the gas bubbles may be raised to decrease the sizes of the gas bubbles 350, 550. Adjustment of the pressure on the gas bubbles 350, 550 is another method of control that allows the sizes of the gas bubbles 350, 550 to be modified after the gas bubbles 350, 550 have already been trapped.

On the other hand, the planar arrangement of the gas bubbles 350, 550 depends mainly on the positions of the concavities 311, 511 on the surface of the base mold 310, 510, and on the arrangement pattern thereof, but the positions of the gas bubbles within the concavities 311, 511 on the base mold 310, 510 can be controlled by, for example, (a) adjusting the interfacial tension between the hardenable fluid 330, 530 and the surface of the base mold 310, 510, and (b) adjusting the viscosity of the hardenable fluid and the time from coating until hardening.

The second replication process in a process for producing the optical member of this embodiment will now be explained with reference to FIGS. 4e-4g and FIGS. 6e to 6g.

An ordinary existing replication process may be used in the second replication process. First, as shown in FIG. 4e and FIG. 6e, the structure 331B, 531B with concave curved surfaces obtained by the first replication process described above is prepared as a second mold (hereinafter, the “structure” may be considered synonymous with “second mold”, where appropriate), and as shown in FIG. 4f and FIG. 6f, the hardenable fluid 360, 560 is coated onto the replication surface of the second mold 331B, 531B without leaving gas bubbles.

The second mold 331B, 531B in the second replication process may be the hardened hardenable fluid that was used in the first replication process described above, but any suitable material may be used according to the purpose of use, such as an ultraviolet curing resin, soluble resin, thermoplastic resin or thermosetting resin, or even another type of organic material, inorganic material or organic/inorganic composite material.

The hardenable fluid 360, 560 to be coated onto the second mold 331B, 531B may be an ultraviolet curing resin or a solution of a soluble resin. If the second mold 331B, 531B has sufficient heat resistance, a thermoplastic resin or thermosetting resin may also be used. Other organic materials, inorganic materials or organic/inorganic composite materials may also be used so long as they are hardenable substances. When the hardened layer is to be released from the second mold 331B, 531B after hardening, it is preferred to select a material that is easy to remove.

The method for coating the hardenable fluid 360, 560 onto the replication surface of the second mold 331B, 531B may be one employing any of various coating apparatuses, such as a knife coater, bar coater, blade coater, roll coater or the like. It is not necessary to trap air in the mold surface in the second replication process, and ordinary existing replication conditions may be employed, such as coating under reduced pressure conditions. Alternatively, reduced pressure treatment, or degassing, may be carried out after coating.

Next, the coated hardenable fluid 360, 560 is hardened and the hardened structure 361, 561 is removed from the second mold 331B, 531B, as shown in FIG. 4g or FIG. 6g. The second mold 331B, 531B may also be left if necessary.

When the hardenable fluid 360, 560 is an ultraviolet curing resin it may be hardened by ultraviolet irradiation, and when it is a soluble resin solution it may be hardened by drying. When the hardenable fluid is a thermoplastic resin, it may be cooled to below the curing temperature of the resin for hardening, and when it is a thermosetting resin, it may be heated to above the curing temperature of the resin for hardening.

Thus, replication of the second mold 331B, 531B obtained by the first replication process can yield a structure 361, 561 provided with convex curved surfaces 362, 562 and partition walls 363, 563 surrounding them. The structure 361, 561 may be used as an optical member with a convex lens array. According to this embodiment, therefore, an optical member with a convex lens array, which has conventionally required a long operating time to form, can be obtained by a simple process without requiring special working.

Since the second replication process does not require arrangement of gas bubbles on the replication surface, it can be replaced by any existing replication process. For example, the second mold may be used for replication by a hot press or electroforming.

The convex lenses on the main surface of the optical member obtained by the second replication process have sizes and shapes corresponding to the gas bubbles 350, 550 trapped in the first replication process. For example, the area of the base section may be between 0.01 μm² and several 100 mm², and the height dimension may be between 0.1 μm and several tens of mm. However there is no limitation to these ranges, and the convex curved surfaces 362, 562 may have any desired dimensions according to the purpose of use.

When the concave curved surfaces 332, 532 of the second mold 331B, 531B are essentially identical in the optical member consisting of the structure 361, 561, the obtained microlens array will have an arrangement of convex lenses with essentially identical shapes.

The obtained optical member has a form with a plurality of convex lenses arranged on the main surface and partition walls 363, 563 surrounding each convex lens. When the partition wall sections are as shown in FIG. 6g, for example, with slanted partition walls 563, the partition walls 563 can also be used as prisms.

As already explained, the partition walls 363, 563 may also be used as spacers when a separate layer is laminated on the obtained optical member. As shown in FIG. 2a and FIG. 2b, the heights of the partition walls can be adjusted to modify the distance between the other member and the convex lenses.

Thus, the topological characteristics of the partition walls 363, 563 can be utilized for a variety of fields and purposes.

An optical member provided with concave lenses or an optical member provided with convex lenses, obtained by the replication process that employs gas bubbles, may be used alone or, as shown in FIG. 2c, it may be used as an optical member with a laminated structure having a single layer or multiple layers further coated on the surface comprising the concave lenses or convex lenses. For example, there may be laminated a scratch resistant protective layer, or a protective layer that increases the antifouling property of the lens sections, or a protective layer that increases the weather resistance to block ultraviolet rays, or there may laminated a resin layer or transparent ceramic layer to adjust the optical refractive index.

Such a laminated structure can also be obtained, for example, by not removing the second mold 331B, 531B from the structure 361, 561, in the step illustrated in FIG. 4g or FIG. 6g.

When only the second mold 331B, 531B is formed of a soluble resin material that is soluble in a specific solution of a water-soluble resin, the optical member may be obtained by dissolving the second mold 331B, 531B in a solvent, instead of physically removing the structure 361, 561 as the optical member from the second mold 331B, 531B in the step illustrated in FIG. 4g or FIG. 6g. Thus, even if the concave curved surfaces 332, 532 of the second mold 331B, 531B have an overhanging cross-sectional shape making it difficult to physically remove the structure 361, 561, the second mold 331B, 531B can be dissolved with a solvent to obtain an optical member without producing damage.

A process for producing an optical member provided with concave lenses or convex lenses according to this embodiment, obtained by a replication process employing gas bubbles, has been explained above, and the optical member obtained by this process has concave lenses or convex lenses, formed by replication of the outer shapes of the gas bubbles, and partition walls or grooves surrounding them. However, when the partition wall sections or groove sections are not absolutely necessary in context of the intended purpose, the unwanted sections may be removed by mechanical, physical or chemical means either during the process or afterwards.

The optical member of the embodiment described above may be used for various purposes including as a diffusion member to substitute for a conventional microlens array, or as an optical member such as a condenser or light guide. Because the process is simple and may form lens shape using the replication of the gas bubble shape, it is possible to provide smooth lenses with low distortion.

The optical member with convex lenses and partition walls or with concave lenses and grooves according to this embodiment can exhibit effects that cannot be obtained by ordinary microlens arrays alone, by making use of not only the lenses but also the shapes of the partition walls or grooves.

A concrete application example of using the optical member of this embodiment will now be described.

### Illumination Device

First, an example of applying the optical member of this embodiment to an illumination device will be described. The illumination device of this embodiment has a luminescent member and, on the light-exiting side thereof, the optical member of this embodiment, and more specifically it is an illumination device with a luminescent member that emits light through a transparent base material with a refractive index higher than 1, and an optical member disposed on the transparent base material.

Examples of luminescent members include those that employ discharge tubes such as fluorescent lamps, as well as light emitting elements such as light emitting diodes (hereinafter referred to as “LED”) and organic electroluminescence (hereinafter referred to as “organic EL”). In most of these illumination devices, light emitted from the light source is emitted into the air through a transparent base material such as glass or resin. In the case of a discharge tube, for example, the light is emitted through a glass cylinder tube. In the case of an LED, whether a surface mounted LED or lamp-type LED, the emitted light is directed outward through a transparent sealing resin made of an epoxy resin layer with a refractive index of about 1.5 or a silicone layer with a refractive index of about 1.4. In the case of an organic EL, it is directed outward usually through a transparent base material such as a glass panel with a refractive index of about 1.5. In both cases, the light is emitted into air through a transparent base material with a high refractive index (hereinafter referred to as “high refractive index transparent base material”) compared to the refractive index of 1 for air space, and therefore reflection tends to be produced at the interface with air.

LEDs and organic ELs are the focus of attention as new generation illumination devices that can substitute for fluorescent lamps because of their energy saving properties, but most of the light is lost at the interface of the high refractive index transparent base material and the low refractive index air. For example, most organic EL elements have a laminated structure comprising a transparent electrode layer, an organic compound layer and a back electrode layer on a glass panel, with positive holes injected from the transparent electrode and electrons injected from the back electrode recombining at the organic compound layer, whereby light is emitted by excitation of a fluorescent substance or the like. The emitted light is directed through the glass panel either directly or by reflection at the back electrode. However, if the refractive index of the organic compound layer is approximately 1.7, the refractive index of the transparent electrode is approximately 2.0 and the refractive index of the glass panel is approximately 1.5, then only less than about 20% of the light is finally emitted outward. Such low light extraction efficiency substantially lowers the luminous efficiency.

The illumination device of this embodiment is provided with the optical member of this embodiment on a high refractive index transparent base material composing the luminescent member. According to this illumination device, it is possible to improve the reduced light extraction efficiency caused by reflection of light produced at the interface between the high refractive index transparent base material and the air space.

FIG. 9a and FIG. 9b are partial general schematic drawings showing the constructions of illumination devices 910 and 920 according to this embodiment. In the illumination device of this embodiment, the luminescent member 913 emits light outward from a luminous light source 911 through the high refractive index transparent base material 912, but an optical member of this embodiment 915 or 916 is disposed on the high refractive index transparent base material 912.

Here, the luminescent member 913 is a discharge tube such as a fluorescent lamp, a light emitting element such as a LED or organic EL, or any device which contains a light emitting element as one of the constituent elements. The high-refraction transparent base material 912 is a transparent base material that has a refractive index at least larger than the refractive index of air (1), and preferably at least 1.3 or at least 1.4. There are no particular restrictions on the shape or thickness of the transparent base material, and various shapes such as laminar, sheet-like, tubular or projectile-shaped may be used. There are also no particular restrictions on the transparency of the transparent base material, and the transparency may be at least 50%, at least 70% or even higher, at least in the wavelength range of the light to be used as the illumination light in the light emitted by the luminescent member.

The optical member used here may be any optical member having on a main surface a microlens array formed using the replication process of this embodiment, that employs a mold comprising a plurality of gas bubbles arranged on the replication surface. For example, as shown in FIG. 9a, an optical member 915 may be used which comprises convex lenses and partition walls surrounding each convex lens, on the high refractive index transparent base material 912. Alternatively, as shown in FIG. 9b, the optical member 916 may comprise a concave lens array and grooves surrounding each concave lens, on the high refractive index transparent base material 912.

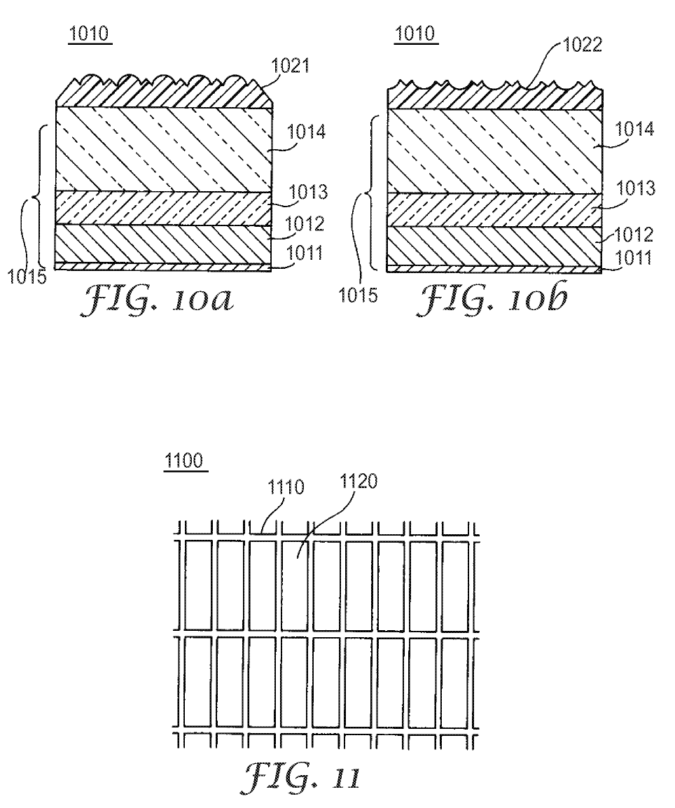

FIG. 10a and FIG. 10b shows examples of an illumination device 1010, 1020 employing an organic EL as the light emitting element. There are no particular restrictions on the structure of the organic EL 1015, and as shown in these drawings, an organic EL may be used having a laminated structure comprising a glass panel 1014, a transparent electrode 1013, an organic compound layer 1012 and a back electrode layer 1011. In this structure, positive holes injected from the transparent electrode 1013 and electrons injected from the back electrode 1011 recombine at the organic compound layer 1012, whereby light is emitted by excitation of a fluorescent substance or the like. The emitted light is directed through the glass panel 1014 together with light reflected at the back electrode layer 1011. On the glass panel 1014 there may be disposed an optical member 1021 comprising the convex lenses and partition walls surrounding them, or an optical member 1022 comprising concave lenses and grooves surrounding them, according to this embodiment.

The illumination device 1010 or 1020 of this embodiment has an optical member 1021 or 1022 disposed on the high refractive index transparent base material 1014, and therefore the presence of the convex or concave lens array and the partition walls or grooves formed surrounding the lenses can improve the light extraction efficiency. That is, when light generated by the light emitting element is emitted through the high refractive index transparent base material 1014 directly into the air space, most of the light is completely reflected at the interface with the air space resulting in large loss of light, but when emission to the air space is through the optical member 1021 or 1022 of this embodiment, the presence of the irregularities on the main surface of the optical member 1021 or 1022 can lower the rate of total reflection at the interface with the air space. As a result, the light loss due to total reflection is reduced and the actual light extraction efficiency can be increased.

Moreover, since the optical member 1021 and 1022 of this embodiment can exhibit a synergistic function by the light diffusion function of the convex lenses or concave lenses and the prism lens function of the partition walls or grooves formed around the lenses, it is possible to provide luminous light having a uniform light distribution across a wider angle, compared to optical members composed only of prisms. That is, it is possible to reduce the difference between central front luminance and peripheral luminance in the illumination device.

Furthermore, when an optical member 1021 or 1022 having convex lenses or concave lenses and prisms surrounding them arranged in the closest packed state on the main surface, virtually the entire side of the main surface of the optical member will function as an optical member, thus effectively reducing light loss due to total reflection and increasing the light extraction efficiency.

There are no particular restrictions on the sizes or shapes of the convex lenses or concave lenses used in the optical member applied in an illumination device according to this embodiment, and the optical member illustrated in FIG. 1a-FIG. 1d may be used or any of other various optical members that can be produced utilizing a process of replicating gas bubbles according to this embodiment. In addition, it is possible to achieve even more satisfactory light distribution by utilizing an optical member that employs the grooves or partition walls around the lenses as prisms.

The sizes and shapes of the prisms formed around the convex lenses or concave lenses are not particularly restricted, and as an example, there may be used a prism with a prism apex angle of 50 degrees or larger or 70 degrees or larger, and no greater than 150 degrees or no greater than 100 degrees.

Such prisms can be obtained using the concavities of not only quadrangular pyramids but also other polygonal pyramids such as triangular pyramids, pentagonal pyramids, hexagonal pyramids or octagonal pyramids, or cones, in the surface of the base mold used for the production process for the optical member of this embodiment. There may also be used, for example as shown in FIG. 23, a base mold having layered concavities with two different pyramidal or conical forms with different apex angle θ values. The apex angle of a prism is affected primarily by the angle of the slanted surface in the concavity of the base mold, and therefore the base mold used may be one wherein the apex angle of the pyramids or cones composing the concavities are at least 50 degrees or at least 70 degrees and no greater than 150 degrees or no greater than 100 degrees.

While there are no particular restrictions on the arrangement of the convex lenses and concave lenses, it will be possible to obtain a higher light utilization efficiency if the convex lenses or concave lenses and their surrounding prism lenses are arranged as densely as possible. Thus, the base mold used for production has concavities composed of pyramids or cones densely arranged on the mold surface, and preferably arranged in the closest packing state.

The material of the optical member 1021, 1022 which is used is a material having a transmittance of at least 60%, at least 70% or at least 80% in the wavelength of light that is to be utilized as the illumination light. As examples of such materials there may be mentioned various synthetic resins such as polyvinyl chloride, fluorine-based resin, polyurethane resin, polyester resin, polyolefin-based resin, acrylic-based resin, methacryl-based resin, silicone resin and epoxy resin, or glass. There are no restrictions on the refractive index, and for example, it may be at least 1.2 or at least 1.3 and no greater than 1.8 or no greater than 1.9.

The optical member used for this embodiment may be a flexible sheet and its thickness is not particularly restricted, but from the point of view of light transmittance the member is preferred to be relatively thin at no greater than 500 μm or no greater than 300 μm.

A pressure-sensitive adhesive material layer may also be provided on the back side of the optical member sheet. By providing a pressure-sensitive adhesive material layer it is possible to easily anchor the optical member onto the luminescent member. In this case, the pressure-sensitive adhesive material layer is preferably one with a transparency of at least 60% or at least 70% at the wavelength of light to be used as the illumination light.

As examples of pressure-sensitive adhesive material layers there may be mentioned acrylic-based resin, silicone resin, urethane-based resin, polyester-based polyamide, polyvinyl alcohol (PVA), ethylene-vinyl acetate (EVA), vinyl-vinyl chloride acetate copolymers resin, polyvinyl ether, saturated amorphous polyester, melamine resin and the like. The method of forming the pressure-sensitive adhesive layer may employ any conventionally known means such as gravure coating, spray coating, curtain coating, impregnation coating or the like.

When the optical member is partially made of a material with an auto-adhesive property such as a silicone resin, the optical member may be directly attached to the luminescent member even without a pressure-sensitive adhesive layer. The structure of the organic EL used as the light emitting element in the illumination device of this embodiment is not particularly restricted, and various types of organic EL may be used. As examples of laminated structures there may be mentioned 1) transparent electrode/organic luminescent layer/back electrode, 2) transparent electrode/organic luminescent layer/electron transport layer/back electrode, 3) transparent electrode/positive hole transport layer/organic luminescent layer/electron transport layer/back electrode, 4) transparent electrode/positive hole transport layer/organic luminescent layer/back electrode, 5) transparent electrode/organic luminescent layer/electron transport layer/electron injection layer/back electrode and 6) transparent electrode/positive hole injection layer/positive hole transport layer/luminescent layer/electron transport layer/electron injection layer/back electrode. These organic ELs are formed on a transparent base such as glass or a transparent resin base.

According to the illumination device of this embodiment, the optical member of this embodiment may be attached to an organic EL to increase the maximum luminous intensity ratio to 1.1 or greater, 1.3 or greater, 1.4 or greater or about 1.5 or greater. The integrated intensity ratio can also be increased to 1.01 or greater, 1.1 or greater, 1.2 or greater or about 1.3 or greater.

As explained above, by applying the optical member of this embodiment in an illuminating luminescent member for the illumination device of this embodiment, it is possible to obtain luminance and light extraction efficiency equal to or surpassing that obtained when using an existing diffusion sheet or prism sheet, and thus contribute to extended life and reduced energy consumption of the luminous devices. The optical member of this embodiment can be produced by a simple process that can easily be applied for large areas, and can therefore be used for large-sized illumination devices.

### Display Device

An example of applying the optical member of this embodiment to a display device will now be described. The display device of this embodiment employs the optical member of this embodiment as the condensing member in a display device having a light-shielding pattern as one of its constituent elements, and can thus minimize light loss caused by the light-shielding pattern and improve the light utilization efficiency.

A representative light-shielding pattern of this type is the lattice-like light-shielding pattern 1100 shown in FIG. 11, and it may be used in a transmission liquid crystal display device or rear-projection screen. In a liquid crystal display panel, for example, each liquid crystal device has a color filter with pixels for the three colors red, green and blue arranged in a periodic fashion and color is produced as light passes through each pixel, but in order to prevent reduced contrast by color mixing at the borders of the pixels, it is common to implement a black matrix, that is a lattice-like light-shielding pattern which shields the border sections that correspond to the pattern of pixels. In a rear-projection screen, a light-shielding pattern is formed on the screen to minimize reduction in contrast due to reflection of external light.

In both cases, although the use of a light-shielding pattern is effective for increasing image contrast, it also reduces light utilization efficiency due to the presence of the light-shielding pattern. In the display device of this embodiment, a display device comprising such a light-shielding pattern has the optical member of this embodiment disposed on the light-incident side of the light-shielding pattern, so that the condensing function of the optical member can be utilized to increase the light quantity transmitted through the openings of the light-shielding pattern and light utilization efficiency can thus be improved.

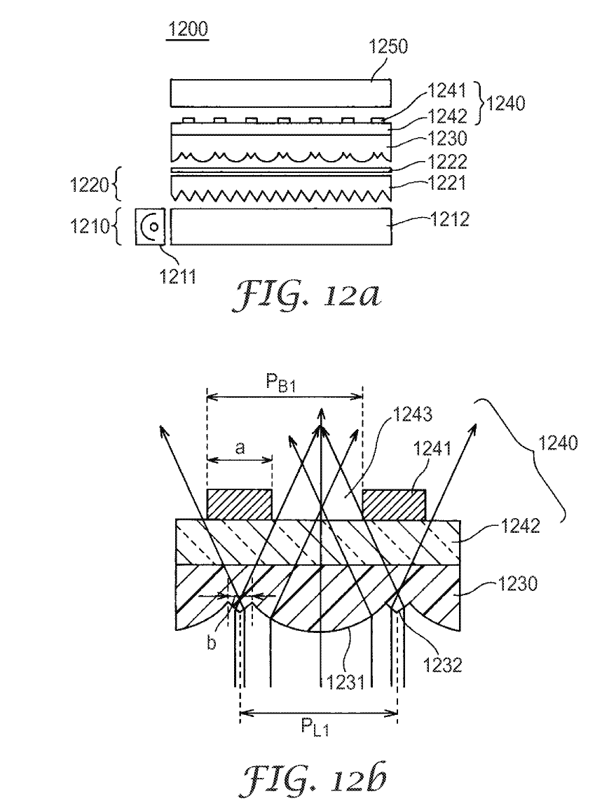

FIG. 12a is a partial schematic block diagram of the display device of this embodiment 1200 employing the optical member of this embodiment. In the display device of this embodiment 1200, the optical member of this embodiment 1230 is disposed between a backlight device 1210 and a black matrix 1240, for example.

On the black matrix 1240 there is disposed a display panel 1250 on which picture elements such as liquid crystal devices are arranged in a two-dimensional fashion. The actual construction of the display panel 1250 is not shown, but as an example, a liquid crystal display panel may be provided with a liquid crystal layer between a pair of panels, one panel being provided with a common electrode layer and a TFT (Thin Film Transistor) switching element, and the other being provided with a transparent electrode layer. A filter layer and common electrode layer may also be formed on the base 1242 on which a black matrix light shielder 1241 is formed. The base 1242 may be a clear film or a glass panel.

The backlight device 1210 comprises a light source 1211 such as a cold-cathode tube or LED, and a light guide 1212. The light source 1211 may be disposed at the end of the light guide 1312 as shown in FIG. 12, or otherwise it may be disposed under the light guide 1212. Between the backlight device 1210 and optical member 1230 there may be placed, as necessary, a turning film 1221 or phase contrast panel 1222, or a diffuser panel or deflection plate (not shown).

FIG. 12b is a partial cross-sectional view showing an example of the construction of the light shielder 1241 of the black matrix 1240 and the optical member of this embodiment. When using an optical member 1230 having convex lenses 1231 and prisms 1232 which are partition walls surrounding them, as seen in this illustration, the center of the convex lens 1231 is disposed approximately at the opening 1243 of the black matrix 1240. Light emitted from the backlight device 1210 and having directivity due to the turning film 1221 is collected at the convex lenses 1231 and prisms 1232 of the optical member 1230, and light that conventionally has been absorbed or reflected by the light shielder 1241 and not effectively utilized is directed to the opening 1243 of the black matrix 1240 and passes through the black matrix. Thus, as a result of the substantially improved transmittance of the black matrix, it is possible to increase the light utilization efficiency.

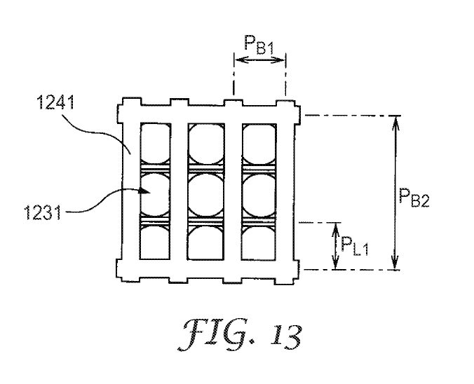

FIG. 13 is a partial front view showing the configurational relationship between the lattice-like light-shielding pattern of the black matrix 1240 and the optical member 1230. It is preferred to use an optical member 1230 with a lens arrangement pattern corresponding to the lattice pattern of the light shielder 1241 of the black matrix. For example, preferably the lattice pattern pitches PB1, PB2 in the longitudinal and transverse directions of the lattice-like light-shielding pattern of the black matrix in this drawing are adjusted to be an integral multiple of the pitch PL1, PL2, respectively, of the arrangement pattern in each direction of the convex lens 1231 of the optical member 1230, with both patterns disposed in a flush manner on both sides.

For example, if the lattice pattern pitch of the light shielder 1241 in the transverse direction of the black matrix is represented as PB1 and the lattice pattern pitch of the light shielder 1241 in the longitudinal direction is represented as PB2, as shown in FIG. 13, and the optical member has a square lattice arrangement pattern with a pitch PL1, having the same pitch PL1 as the lattice pattern pitch PB1 of the light shielder 1241 (PB1=PL1) in the transverse direction while having a pitch PL1 that is ⅓ of the lattice pattern pitch PB1 of the light shielder 1241 (PB2=3×PL1) in the longitudinal direction, then it will be possible to place the lattice-like light-shielding pattern of the black matrix flush with the lens arrangement pattern of the optical member.

The optical member used in the display device of this embodiment may be not only one having a form with convex lenses and partition walls surrounding them as shown in FIG. 12b, but also an optical member as shown in FIG. 1a, FIG. 1b and FIG. 1d, or any other optical member of a type produced by a replication of gas bubble shape according to this embodiment, so long as the same condensing function can be exhibited.

The optical member of this embodiment is preferably transparent in the wavelength range of light used in the display. For example, it may be one exhibiting transmittance of at least 50%, 70% or 80% in the wavelength range of visible light (400 nm-800 nm).

The optical member arrangement used in the display device of this embodiment is not limited to that shown in FIG. 12b, as it is sufficient if the condensing function is exhibited, and the main surface of the optical member on which the lenses are formed may be disposed facing the backlight 1210 side, or disposed facing the display panel 1250.

In order to further increase the light utilization efficiency of the display device of this embodiment, the focal length of the optical member is preferably adjusted according to the distance from the black matrix. Adjustment of the focal length of the concave lenses or convex lenses can be accomplished by varying the lens curvature or by modifying the refractive index of the material forming the lenses, and these can be controlled by modifying the sizes and shapes of the gas bubbles trapped in the base mold during the replication process. The condensing function of the prisms composed of the grooves or partition walls around the concave lenses or convex lenses can also be controlled by adjusting the angle of the slanted surfaces in the concavities of the base mold or by adjusting the refractive index of the material composing the prisms.

On the other hand, as shown in FIG. 2c, a covering layer with a different refractive index may be provided on the main surface of the optical member to adjust the focal length. For example, when a layer with a lower refractive index than the optical member is laminated as a covering layer, the refraction angle at the interface between the covering layer and the optical member can be made smaller than the refraction angle at the interface between the air space and the optical member, thus lengthening the focal length of the convex lenses and prisms. For example, the optical member may be formed of an acrylic resin with a refractive index of 1.5 and a silicone resin with a refractive index of 1.4 laminated on the main surface to lengthen the actual focal length.

As explained above, by combining the optical member of this embodiment with a black matrix that is used in a transmission liquid crystal display device or rear-projection screen, the actual transmittance of the black matrix can be increased and the light utilization efficiency of the display improved in the display device of this embodiment.

### Light Guide

An example of using the optical member of this embodiment as a light guide member will now be described. This example concerns, in particular, a light guide for an input device.

A light guide is a device that directs light from a line light source such as a cold-cathode tube or a point light source such as a light emitting diode (LED), that has entered at one end. A planar light guide used in the backlight device of a liquid crystal display is used to convert the light from a point light source or line light source into surface emission. Recently, it has been used for illumination of the input key sections of cellular phones and personal computers.

The surfaces of such light guides normally have microirregularities that function to guide light in a prescribed direction. These irregularities have conventionally been formed by methods of forming dots by printing, methods of press forming for embossing, or replication methods using metal dies produced by polishing, but the light guide of this embodiment employs the optical member of this embodiment as a light guide. The irregularities on the light guide surface may be the concave lenses or convex lenses obtained by replication of the gas bubble shape, or the grooves or partition walls surrounding the lenses. The lens surfaces formed by replication of gas bubble shape can be provided by a simple process as extremely smooth lens surfaces, while also having low light scattering loss due to roughness of the lens surfaces.

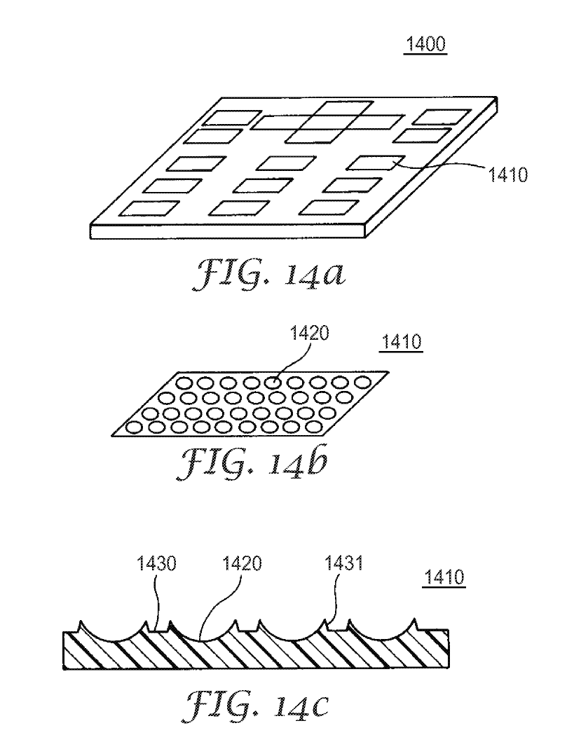

FIG. 14a-FIG. 14c show a light guide to be used for illumination of input keys in a cellular phone, as an example of a light guide employing the optical member of this embodiment. FIG. 14a is a perspective view showing the structure of the light guide. The light guide 1400 has light guiding regions 1410 at locations corresponding to the positions of the input keys of the cellular phone. Each light guiding region 1410 has approximately the same two-dimensional configuration and area as the corresponding input key, and as shown in FIG. 14b, for example, multiple fine concave lenses 1420 are arranged in the regions.

FIG. 14c is a partial cross-sectional view showing an example of the shape of the light guiding region 1410. As seen in the same drawing, a plurality of concave lenses 1420 and grooves 1430 surrounding them are formed in the light guiding region 1410 by the replication process using gas bubbles. The side walls 1431 of the grooves 1430 have slanted surfaces and exhibit a prism function. The diameters of the concave lenses used here are at least about 10 μm and no greater than 1 mm, and typically may be at least about 30 μm and no greater than 100 μm. Several dozen or a hundred or more of these concave lenses may be formed if necessary in each light guiding region 1410.

FIG. 15 is a partial cross-sectional view of an input device, showing an example where the aforementioned light guide employing the optical member of this embodiment is mounted in an input device used in a portable terminal requiring input keys, such as a cellular phone or personal computer. In the input device 1500 shown in this drawing, under an input screen with an arrangement of multiple input keys 1510 there are arranged dome-shaped metal members (metal domes) 1560 that correspond to each of the input keys and deform when the input keys 1510 are pressed. These metal domes 1560 are covered by a dome sheet 1550 with domed shapes along the metal domes. The light guides 1520 may be disposed between the input keys 1510 and the dome sheet 1550, as shown in this drawing. At one edge of the light guide there is provided a light source 1530 such as one or more light emitting diodes. Light leaving the light source 1530 enters into the light guide 1520 from the edge of the light guide 1520 and is directed toward the input key 1510 regions by the light guiding regions with multiple concave lenses 1521, thus illuminating each input key 1510.

The light guide 1520 of this embodiment may be the optical member of this embodiment in sheet form, having transparency for the wavelength of light generated by the light source 1530, and having flexibility allowing deformation to follow the movement of the metal domes 1560 that move vertically by pressing force of the input keys 1510.

Also, when a plurality of concave lenses or convex lenses are arranged in a highly dense fashion in prescribed regions corresponding to the arrangement of the input keys, as in the optical member used as the light guide for this embodiment, a mold having the corresponding concavity pattern may be used as the base mold for fabrication. For example, a base mold such as shown in FIG. 7c with a prescribed concavity pattern can be easily prepared by opening prescribed sections of the resin layer of a two-layer structure sheet composed of a metal sheet and a resin layer by laser working to form concavities.

As explained above, the optical member of this embodiment may be used as a light guide. Particularly when it is to be used as a light guide for illumination of prescribed locations such as input keys, a sheet-like optical member according to this embodiment having a condensation pattern of multiple concave lenses or convex lenses arranged in a prescribed region may be provided as the light guide. Since the individual concave lenses and convex lenses have smooth curved surfaces formed by a method of replicating gas bubble shape in the optical member of this embodiment, it is possible to provide a light guide with minimal light scattering loss and high light utilization efficiency.

The light guide may be employed for a variety of purposes other than in cellular phones or personal computers as described above. By changing the arrangement pattern of lenses according to the requirement of the purpose of use, it is possible to use the optical member of this embodiment as a light guide for many other different purposes.

### Microlens Sheeting

An example in which the optical member of this embodiment is applied in a microlens sheeting capable of providing a three-dimensional composite image will now be described.

The three-dimensional composite image provided using the microlens sheeting of this embodiment is formed so that the eye perceives the composite image to be above or below the sheeting, and the image changes as the observer changes viewing angles and distance. Because the image appears to float above or below the microlens sheeting, the image is also referred to as a “floating image”.

An example of the microlens sheeting used to form a floating image is described in patent gazette W01/063341, the sheeting including microlens layers and a radiation sensitive material layers provided adjacent to the microlens layers. The same publication describes an example in which a single layer of glass beads partially embedded in a binder layer is used as the microlens layer, and an example in which a resin microlens array layer is used as the microlens layer.

However, when the microlens layer with the glass beads is used, scratch resistance and heat-resistance are excellent, but it is difficult to arrange the glass beads densely on a surface, and so resolution is limited and it is difficult to obtain a sharp image. At the same time, when a resin microlens array is used, a die is used in the manufacturing process, and so work is required to manufacture the die. Also, though it is possible to obtain a high resolution by densely arranging microlenses, scratch resistance is poor in comparison to that of the glass beads. When the resin microlenses are used, lens surfaces are exposed to an air space in order to obtain a necessary refractive index. Thus, the resin microlenses have the particular problem of the lenses being easily scratched and dust easily adhering to the surfaces.

The microlens sheeting of this embodiment solves the problems of the previously explained microlens sheeting for producing a three-dimensional composite image by forming the microlens layer using the optical member of this embodiment. Specifically, as shown in FIG. 2a, the optical member used as the microlens layer has a layer structure including an optical member 211 having convex lenses 212 and partition walls 214 obtained by replicating gas bubble shape formed to surround the convex lenses 212, and a protective film 270 provided on the optical member 211 so as not to be in contact with the front sides of the convex lenses 212. Employing the optical member of this embodiment in the microlens sheeting makes it possible to form the microlens array using a simple process. Moreover, it is possible to fix the protective film in place while keeping an air space above the layer of densely arranged convex lenses. Therefore, it is possible to provide the microlens sheeting with high scratch resistance and antifouling properties, and high resolution, while maintaining lens function.

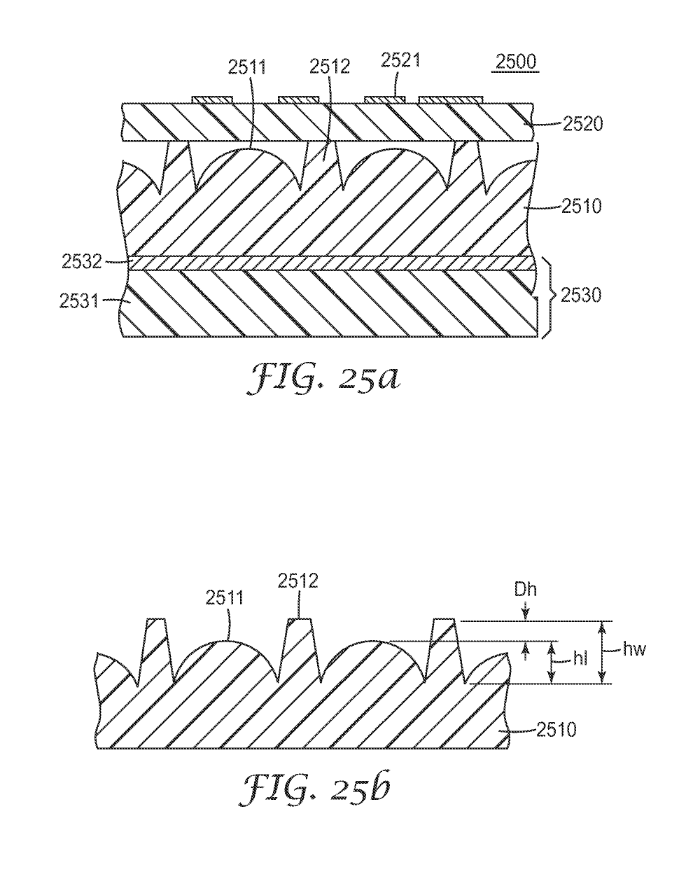

The structure of the microlens sheeting of this embodiment will now be described in detail with reference to the drawings. FIG. 25a is a partial simplified cross-sectional view of the microlens sheeting 2500 of this embodiment. The microlens sheeting 2500 is constructed from a microlens array 2510 formed by an optical member including the convex lenses of this embodiment, which are obtained by a replication process employing the gas bubbles of this embodiment; a radiation sensitive layer 2530 provided adjacent to the microlens array 2510; and a protective material 2520 provided on a lens surface side of the microlens array 2510.

As shown in FIG. 25b, the microlens array 2510 includes partition walls 2512 surrounding the convex lenses 2511, and a height hw of the partition walls is at least greater than a convex lens height hl. Here, a base point for height is a boundary point of the partition wall 2512 and a curved surface of the convex lens 2511. Thus, a height difference Dh exists between highest portions of exposed surfaces of the partition walls 2512 and highest portions of exposed surfaces of the convex lenses 2511. A result of the existence of the partition walls 2512 having the exposed surfaces higher than the surfaces of the convex lenses 2511 is that the sheet-like protective material 2520 is supported by the partition walls 2512 when provided on the microlens array 2510, and the surfaces of the convex lenses 2511 can therefore be maintained in a state of not being in contact with the protective material 2520. The height difference Dh should be sufficient to allow the aforementioned function and may, for instance, be 1 μm or more and 5 μm or less. When the microlens array 2510 is formed using a resin material, a space between the lenses and the protective material 2520, that is the air space, is maintained, and so it is possible to cover the easily-scratched lens surfaces with the protective material 2520 while retaining a difference in refractive index necessary to allow the microlens array to function as lenses. Thus, it is possible to improve scratch-resistance and prevent dust and stain from adhering to the surfaces of the convex lenses 2511.

Here, the microlens array 2510 can be formed using the optical members of the previously explained embodiment which exhibit transparency in the visible region (400 nm to 800 nm). The height of the surfaces of the convex lenses 2511 of the microlens array 2510 can be adjusted by adjusting, in the process for replicating gas bubble shape, a shape and a size of the gas bubbles using the various control methods already described in this specification. Note that it is preferable that a thickness of the microlens array 2510 is adjusted so that focal points of the microlenses fall on a radiation sensitive film 2532 of the substantially adjacent radiation sensitive layer 2530. The thickness can be adjusted by adjusting a thickness of a resin coating when forming the microlens array 2510.

A diameter of the microlens and pitch of the microlenses in the optical member usable as the microlens array 2510 are not particularly limited. A size of the image to be formed can be selected based on a degree of minuteness. Unlike the case of the microlense layer formed from glass beads, with the optical members of this embodiment it is possible to densely arrange the microlenses, and thus to form high-resolution images.

As the protective material 2520, a material that exhibits transparency in the visible light range can be used. For instance, a material with a transmittance of greater than, 70%, 80% or 90% can be preferably used. The material can be formed from a commercially available material such as a synthetic resin exemplified by polyvinyl chloride fluorine-based resins, polyurethane resins, polyester resins, polyolefin-based resins, acrylic resins, methacryl-based resins, silicone resins, epoxy resins and the like; silicon oxide; titanium oxide; or ceramics such as various glass materials. While the thickness is not particularly limited, the protective material 2520 should be thick enough to retain a strength as required of a protective material and thin enough to maintain transparency. For example, sheet-like or film-like materials with a thickness of at least 10 μm or at least 30 μm, and no greater than 5 mm, 1 mm, or 500 μm can be used. Though not shown in FIGS. 25a and 25b, an adhesive layer may be further provided on a surface of the protective material 2520 to fix the microlens array 2510 and the protective material 2520 together. Also, anti-reflective film may be further provided on a surface of the microlens array 2510 or the protective material 2520.

Moreover, a printed layer 2521 can be formed on the front side or a back side of the protective material 2520. By combining a two-dimensional image provided on the printed layer 2521 that is formed on the protective material 2520 with the three-dimensional floating image, it is possible to form a more complex image and further extend a range of application.

The radiation sensitive layer 2530 is a radiation sensitive material on which it is possible use irradiation to record a pattern corresponding to the floating image (subject image). For example, it is possible to use the radiation sensitive material described in patent gazette WO01/633341. Any material which allows the introduction of a difference in contrast between portions exposed to a predetermined level of visible light or other irradiation and unexposed portions through composition change, ablation of the material, a change in phase, or the like can be used. Specifically, the material can be a film formed from a metal, a polymer, a semiconductor material, or a mixture of these materials.

FIG. 25a shows an example in which the radiation sensitive layer 2530 is the radiation sensitive film 2532 formed by metal deposition or the like on a transparent film made of PET or the like. Examples of such metal radiation sensitive materials include aluminum, silver, copper, gold, titanium, lead, tin, chromium, vanadium, tantalum, and alloys and oxide films of these metals. These metal radiation sensitive materials may be irradiated using, for example, excimer flashlamps, passively Q-switched microchip lasers, Q-switched Neodymium-doped yttrium aluminum garnet (Nd: YAG), Neodynium-doped yttrium lithium fluoride (Nd: YLF), Titanium-doped sapphire (Ti:sapphire) lasers, or the like. The radiation sensitive material of the irradiated portion can then be removed by ablation.

It is possible to use a known image forming method as described in WO01/063341 to form the pattern for the subject image in the radiation sensitive layer 2530. For example, the microlens sheeting may be irradiated with laser light first passed through an optical train for collimating and then focused in such a way that a focal point is above or below the microlens sheeting. The laser light is refracted at a predetermined angle at each of the microlenses and caused to converge on the radiation sensitive film 2532 of the radiation sensitive layer 2530. The radiation sensitive film 2532 of the irradiated portion is removed by ablation. An irradiation position of the laser light is then moved based on a pattern of the subject image to draw the pattern of the subject image in the radiation sensitive layer 2530.

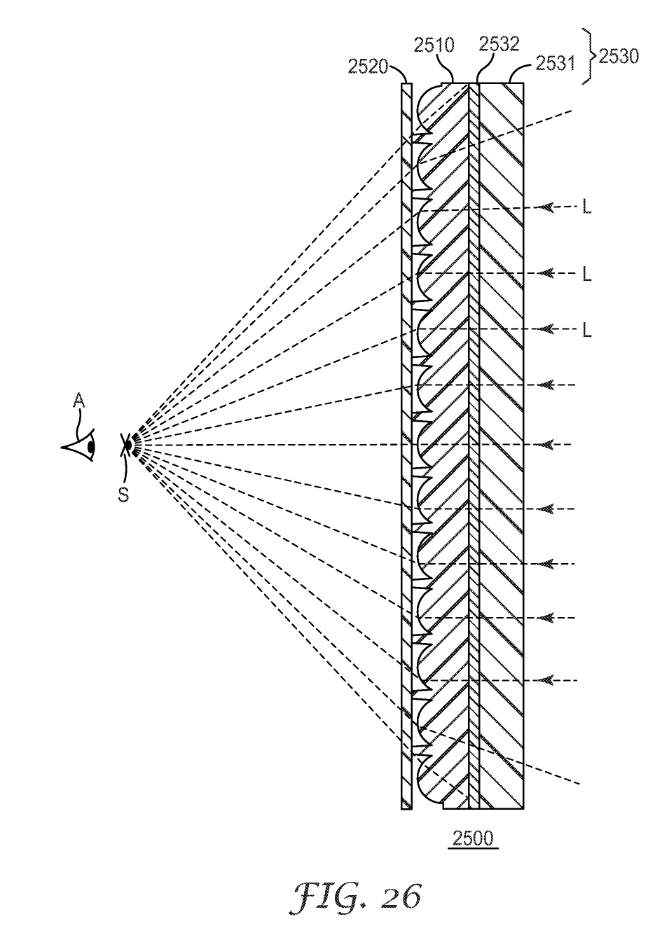

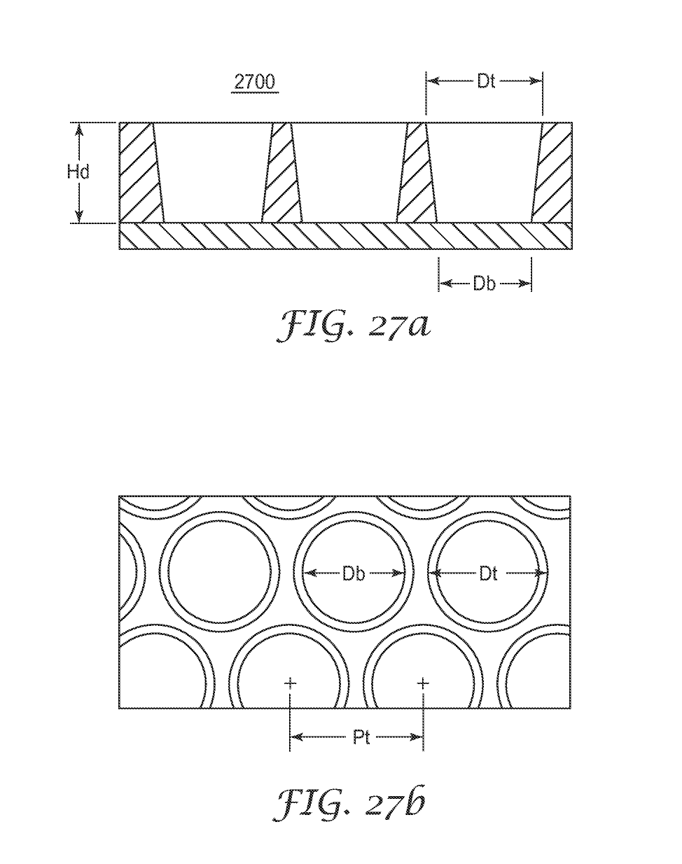

FIG. 26 is a simplified view of an example of a floating image observed using the microlens sheeting 2500 of this embodiment. When a back surface of the microlens sheeting 2500, which is to say an exposed side of the radiation sensitive layer 2530 is irradiated with light (L), the light passes selectively through the radiation sensitive film 2532 according to where an image pattern has been replicated. After being refracted by the exposed surfaces of each of the microlenses of the optical member 2510, the light passes through the protective material 2520, and forms an image in front of the microlens sheeting 2500. As a result, to an observer (A), it appears just as if an image (S) of the subject image is floating in front of the microlens sheeting 2500.

Note that while FIG. 26 shows a case in which the microlens sheeting 2500 is irradiated from the rear surface side (the side on which the microlenses are not exposed), if a metal film, or the like, that is capable of reflecting light is used as the radiation sensitive film 2532, light incident on a front surface of the microlens sheeting 2500 can be reflected by the radiation sensitive film 2532, and the floating image can therefore be obtained using this reflected light alone. In other words, regardless of whether transmitted light or reflected light is used, the floating image will be viewable by the naked eye.

A position at which the image is formed can be adjusted by adjusting a position of a focal point of the irradiating laser when drawing the image pattern on the radiation sensitive layer 2530. Besides forming the image in front of the microlens sheeting 2500, it is also possible to form the image behind the microlens sheeting 2500.

The image obtained with the microlens sheeting of this embodiment differs from a holographic image in being difficult to copy, making the image suitable for use in passports, ID badges, event passes, credit cards, product recognition formats, and in verification and recognition advertising as an image that is secure and cannot be used illegitimately. Further, based on design characteristics of the floating image, the microlens sheeting can be widely used in graphic applications such as in distinctive imaging for lettering, and the like on police cars, fire trucks, and emergency vehicles, in information presentation images of kiosks, electrically lit night-time displays, vehicle dash boards, and the like; in decoration of business cards, name-tags, pieces of art, clothes, shoes, watches, clocks and packaging such as cans, bottles and boxes.

A concrete example of use of the optical member of this embodiment has been explained above, but the optical member of this embodiment is not limited to the usage described and may be employed for a variety of optical purposes either as the optical member alone or in combination with other members. For example, it may be used for purposes in which microlens array sheets or prism sheets are commonly employed, such as optical purposes including display devices or projection screens. It may also be used for other types of optical purposes, for example, as a substitute for light diffusing materials that employ glass beads, or as a retro-reflective material.

### EXAMPLES

Examples of the optical member of the invention and devices employing it will now be explained, with the implicit understanding that the scope of the invention is not limited to the examples.

### Example 1-1

An optical member with a concave lens array was fabricated under the following conditions.

An ultraviolet curing resin was used as the hardenable fluid. The ultraviolet curing resin was prepared by mixing 90 parts by weight of a polyester-based urethane acrylate monomer (trade name: EBECRYL8402 by Daicel-Cytec Co., Ltd.), 10 parts by weight of unsaturated fatty acid hydroxyalkyl ester-modified E-caprolactone (trade name: Placcel™ FA2D by Dicel Chemical Industries, Ltd.) and 1 part by weight of a photopolymerization initiator (trade name: Irgacure 2959, CIBA Specialty Chem. Inc.).

A polypropylene base mold was also prepared by the following method. First, grooves were formed in a copper sheet surface with a cutting machine. The copper sheet was then immersed in an oxidizing agent for oxidation of the copper sheet surface, and then an electrodeposition process was used to form a nickel layer on the oxidized copper sheet surface. Next, the nickel layer was removed (released) from the copper sheet to obtain a nickel mold with concavities in the mold surface. An electrodeposition process was then used to form a nickel layer on the nickel mold surface. Next, the nickel layer was released from the nickel mold to obtain a nickel mold with convexities in the mold surface. A polypropylene resin (commercially available under the trade designation POLYPRO3445 from Exxon Mobil Co.) was melted at a temperature of 200° C.-250° C. and cast onto the surface of the nickel mold having convexities on the mold surface, and then cooled to room temperature (approximately 25° C.) to harden the polypropylene resin and form a hardened layer. The hardened layer was released from the nickel mold to obtain a polypropylene base mold. Thus, a flexible polypropylene sheet-like base mold was prepared having on the mold surface square pyramidal concavities with depths of 50 μm, apex angles of 90 degrees and square bases with side lengths of 100 μm, and arranged in a square lattice pattern at a pitch of 100 μm.

A small rectangular strip with a width of 8 cm and a length of 10 cm was cut out from the sheet-like base mold. The base mold strip was attached onto a polyethylene terephthalate (PET) film with a thickness of 50 μm, a width of 15 cm and a length of 30 cm (commercially available under the trade designation TEIJIN TETRON FILM A31 from Teijin DuPont Films Japan Limited.) using double-sided tape (commercially available under the trade designation Scotch® Tape ST-416 from 3 M Company) with the mold surface exposed.

A PET film made of the same material and with a thickness of 50 μm, a width of 15 cm and a length of 30 cm was prepared as a transparent cover film, and after placing it on the aforementioned PET so as to cover the surface of the base mold, the two PET films were attached on one side edge with masking tape (commercially available under the trade designation Scotch® Sealing Masking Tape 2479S from 3M Company).

With the side edge of the cover film affixed to the PET film, the cover film was opened to expose the surface of the base mold and approximately 10 cc of the liquid ultraviolet curing resin was dropped along the regions where the concavities of the base mold had been formed. The viscosity of the ultraviolet curing resin was approximately 10,000 mPas (measured with a Brookfield viscometer).

In this state, the PET film and cover film attached to the base mold were set in a knife coater. The blade edge height was adjusted so that the gap between the base mold surface and the blade (knife) edge was 200 μm, and the ultraviolet curing resin was spread onto the surface of the base mold with the concavities while moving under the blade at a fixed speed (coating speed) of approximately 16 cm/sec. The cover film was also moved under the blade, matching the coating speed, to laminate the coating layer with the cover film. Gas bubbles were trapped in each concavity of the base mold during the coating. A coating layer of the ultraviolet curing resin was formed on the coated base mold surface while the cover film was laminated on the coating layer.

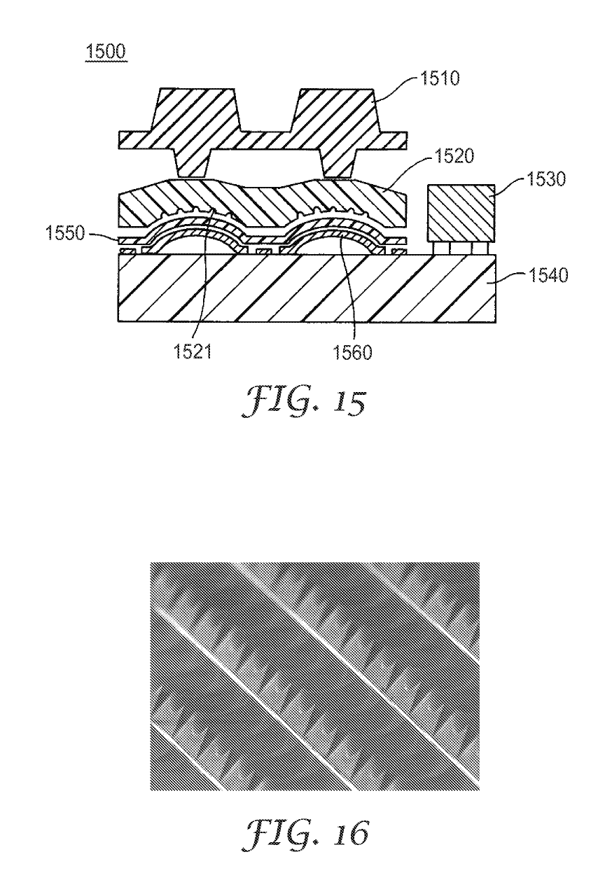

Next, an ultraviolet lamp (Ushio Inc.) was used to irradiate ultraviolet rays at 3450 mJ/cm² onto the coated ultraviolet curing resin through the transparent cover film, for polymerization and hardening of the ultraviolet curing resin. The hardened layer was then released from the polypropylene base mold together with the cover film. Thus, an optical member with concave lenses obtained by replication of gas bubbles (a structure with an arranged pattern of concavities) was obtained. FIG. 16 shows an SEM photograph of the surface of the obtained optical member.

### Example 1-2

An optical member with a convex lens array was fabricated under the following conditions.

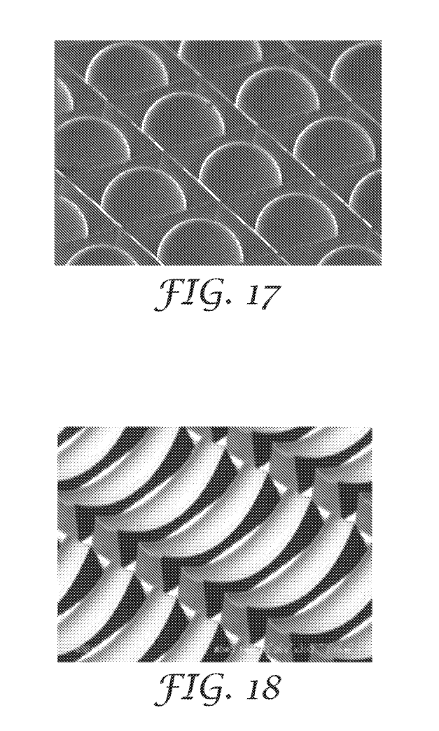

As the hardenable fluid there was prepared a 20 wt% aqueous solution of PVA-217, obtained by mixing 20 parts by weight of a water-soluble resin, polyvinyl alcohol (commercially available under the trade designation KURARAY POVAL PVA-217 from Kuraray Co., Ltd.), and 80 parts by weight of distilled water. The structure with the arranged pattern of concavities produced in Example 1-1 was used as the second mold. The 20 wt % aqueous solution of PVA-217, as a hardenable fluid, was dropped onto the arranged pattern of concavities on the second mold. Next, in order to prevent gas bubble defects, the surrounding area was degassed by pressure reduction for about 15 minutes at below 1000 Pa. Next, a knife coater was used to spread out the hardenable fluid, to obtain a coating layer with a thickness of 200 μm. The obtained coating layer was dried for 2 hours in an oven at 60° C., and then further dried overnight (about 12 hours) at room temperature (approximately 25° C.) to form a hardened layer. The hardened layer was then released from the second mold. Thus, an optical member with convex lenses obtained by replication of gas bubble forms (a structure with an arranged pattern of convexities) was obtained. FIG. 17 shows an SEM photograph of the obtained arranged pattern of convexities.

### Example 1-3

An optical member with a concave lens array was fabricated.

Three different optical members were fabricated using the same ultraviolet curing resin as in Example 1-1, but under hardening conditions of 0 minutes, 30 minutes and 60 minutes as the time until the beginning of hardening, that is the time after coating of the ultraviolet curing resin until ultraviolet irradiation was conducted. The other production conditions were the same as in Example 1-1. The three different optical members obtained in this manner were photographed with a scanning electron microscope (VE-7800, product of Keyence Corp.) and the mean diameter of the concave lenses was measured from the image (hereinafter referred to as “SEM image”). The maximum diameter of the concave lenses was measured at 5 locations in the SEM image in which the obtained concave lenses were observed from above almost vertically, and the average value was determined as the mean diameter of the concave lenses.

With 0 minutes, 30 minutes or 60 minutes as the time until the beginning of hardening, the mean diameters of the obtained concave lenses were 78.7 μm, 78.4 μm and 78.0 μm, respectively.

### Example 1-4

An optical member with a concave lens array was fabricated.

A nickel sheet with square columnar concavities was used as the base mold.

Specifically, there was prepared a nickel sheet having on the mold surface a pattern of square columnar concavities with square bases having sides of 115 μm and depths of 80 μm, arranged in a square lattice at a pitch of 140 μm. The nickel sheet was formed by the method described in Example 1-1.

An optical member was fabricated under the same conditions as Example 1-1, except for using the nickel base mold. The obtained optical member (the structure with an arranged pattern of concavities) had an arrangement pattern with multiple concave lenses of substantially the same shape, and each concave lens was surrounded by a groove.

### Example 1-5

An optical member with a convex lens array obtained by replication of gas bubbles was fabricated under the same conditions as Example 1-2, using the optical member obtained in Example 1-4 (the structure with the arranged pattern of concavities) as the second mold.

The obtained optical member had a pattern with an arrangement of multiple convex lenses of substantially the same shape, and partition walls were formed around each convex lens with the sides of the partition walls roughly perpendicular to the main surface direction of the optical member.

### Example 1-6

An optical member with a concave lens array was fabricated.

A nickel sheet with square pyramidal concavities was used as the base mold. Specifically, there was prepared a nickel base mold having on the mold surface a pattern of square pyramidal concavities with square bases having sides of 25 μm and square top surfaces having sides of 50 μm, arranged in a square lattice at a pitch of 50 μm. The nickel sheet was formed by the method described in Example 1-1. Otherwise, the same conditions were used as in Example 1-1, to fabricate an optical member with a concave lens array obtained by replication of gas bubbles.

### Example 1-7

An optical member with a convex lens array was fabricated using the optical member obtained in Example 1-6 (the structure with the arranged pattern of concavities) as the second mold.

As the hardenable fluid there was prepared a 15 wt % aqueous solution of PVA-205, obtained by mixing 15 parts by weight of the water-soluble resin polyvinyl alcohol (commercially available under the trade designation KURARAY POVAL PVA-205 from Kuraray Co., Ltd.) and 85 parts by weight of distilled water. Except for using this 15 wt % aqueous solution of PVA-205, the same conditions were used as in Example 1-2, to fabricate an optical member with a convex lens array obtained by replication of gas bubbles.

### Comparative Example 1

After coating the ultraviolet curing resin, it was allowed to stand for 15 minutes in a vacuum for degassing of the gas bubbles trapped during coating. Otherwise, the structure was fabricated under the same conditions as Example 1-1. The obtained structure comprised convex square pyramids (pyramidal shapes) by direct replication of the concavities in the base mold, without formation of concave lenses by replication of gas bubbles.

### Example 2-1

An optical member with a concave lens array was fabricated under the following conditions.

As the hardenable fluid there was prepared a 20 wt % aqueous solution of PVA-205, obtained by mixing 20 parts by weight of the water-soluble resin polyvinyl alcohol (commercially available under the trade designation KURARAY POVAL PVA-217 from Kuraray Co.,) and 80 parts by weight of distilled water. Except for the type of resin, the same conditions were employed as in Example 1-1 for coating of the resin onto the base mold and formation of a coating layer. Specifically, a knife coater was used to coat an aqueous solution containing a water-soluble resin onto the base mold at a coating speed of 16 cm/sec, while trapping air surrounding the base mold, to form a coating layer.

The obtained coating layer was then dried for 2 hours in an oven at 60° C., and then further dried overnight (about 12 hours) at room temperature (approximately 25° C.) to form a hardened layer. Next, the hardened layer was released from the base mold to obtain an optical member having a concave lens array composed of the water-soluble resin (a structure with an arranged pattern of concavities). The curvature of the concave lenses in the obtained optical member was lower compared to Example 1-1.

### Example 2-2

An optical member with a convex lens array was fabricated under the following conditions.

The structure with concave curved surfaces produced in Example 2-1 was used as the second mold, and the same ultraviolet curing resin used in Example 1-1 was coated onto the second mold to a thickness of 200 μm, after which a release-treated PET film with a thickness of 50 μm was laminated thereover.

Using the same type of ultraviolet lamp as in Example 1-1, ultraviolet rays were irradiated at 3450 mJ/cm² from the release-treated PET film side to polymerize the ultraviolet curing resin and obtain a hardened layer. Next, the hardened layer was released from the second mold to obtain an optical member having an arrangement of convex lenses composed of the ultraviolet curing resin.

### Example 2-3

Six optical members with concave lens arrays, having different sizes, were fabricated under the following conditions.

As the hardenable fluids there were prepared 5 wt %, 10 wt %, 15 wt %, 20 wt %, 25 wt % and 30 wt % aqueous solutions of PVA-205, obtained by mixing the water-soluble resin polyvinyl alcohol (commercially available under the trade designation KURARAY POVAL PVA-205 from Kuraray Co., Ltd.) with distilled water. The viscosity of each aqueous solution, calculated from the catalog value, is shown in Table 1. After preparing each aqueous solution, aqueous solutions of a water-soluble resin at different concentrations were coated onto polypropylene base molds under the same conditions as in Example 2-1 at a coating speed of 16 cm/sec to a thickness of 200 μm, while trapping the air surrounding the base molds, to form coating layers. Each of the obtained coating layers was dried for 2 hours in an oven at 60° C., and then further dried overnight (about 12 hours) at room temperature (approximately 25° C.) to form a hardened layer. Next, each hardened layer was released from the base mold to obtain optical members having concave lens arrays and composed of the six different water-soluble resins.

SEM images of the obtained optical members were taken, and the mean diameters of the obtained concave lenses were determined from the photographed images by the same method as in Example 1-3. The results are shown in Table 1.

TABLE 1

| | | | | | Mean |
|---|---|---|---|---|---|
| | | Resin | | | diameter of |
| | Drying | concen- | | Coating | concave |
| | temperature | tration | Viscosity | speed | lenses |
| Resin | [° C.] | [%] | [mPa · s] | [cm/sec] | [μm] |
| PVA-205 | 60 to 25 | 5 | 9 | 16 | 72.05 |
| | | 10 | 40 | | 77.20 |
| | | 15 | 180 | | 83.33 |
| | | 20 | 500 | | 89.09 |
| | | 25 | 3000 | | 90.48 |
| | | 30 | 7000 | | 87.94 |

### Example 2-4

Six optical members with concave lens arrays, having different sizes, were fabricated under the following conditions.

As the hardenable fluid there was prepared a 20 wt % aqueous solution of the water-soluble resin polyvinyl alcohol (commercially available under the trade designation KURARAY POVAL PVA-205 from Kuraray Co., Ltd.). Six samples were prepared by using the same type of polypropylene base mold as in Example 1-1 to coat the aqueous solution of the water-soluble resin onto a base mold to a thickness of 200 μm at a coating speed of 16 cm/sec, while trapping the air surrounding the mold.

Next, each sample was dried for 2 hours in an oven adjusted to the different temperature conditions listed in Table 2, and then dried overnight (approximately 12 hours) at room temperature (approximately 25° C.) to form a hardened layer. Each hardened layer was then released from the base mold to obtain six different optical members having concave curved surfaces composed of the water-soluble resin. SEM images of each of the obtained optical members were taken from above the optical member, and the mean diameter as observed from above the obtained concave lenses was determined from the photographed image by the same method as in Example 1-3. The results are shown in Table 2.

TABLE 2

| | Oven | Resin | Coating | Mean diameter of |
|---|---|---|---|---|
| | temperature | concentration | speed | concave lenses |
| Resin | [° C.] | [%] | [cm/sec] | [μm] |
| PVA-205 | 25 | 20 | 16 | 63.84 |
| | 60 | | | 89.09 |
| | 80 | | | 97.12 |
| | 100 | | | 95.84 |
| | 120 | | | 105.18 |
| | 140 | | | 105.70 |

### Example 2-5

Three optical members with concave lens arrays, having different sizes, were fabricated under the following conditions.

As the hardenable fluid there was prepared a 20 wt % aqueous solution of the water-soluble resin polyvinyl alcohol (commercially available under the trade designation KURARAY POVAL PVA-205 from Kuraray Co., Ltd.). The aqueous solution was coated while trapping the air surrounding the base mold, at the coating speed listed in Table 3, to form coating layers. The coating conditions besides the coating speed were the same conditions as in Example 2-1. Each obtained coating layer was dried for 2 hours in an oven at 60° C., and then further dried overnight (about 12 hours) at room temperature (approximately 25° C.) to form a hardened layer. Next, the hardened layer was released from the base mold to obtain an optical member having a concave lens array composed of the water-soluble resin (a structure with an arranged pattern of concavities). SEM images of the obtained optical members were taken, and the mean diameters of the obtained concave lenses were determined from the photographed images by the same method as in Example 2-3. The results are shown in Table 3.

TABLE 3

| | Oven | Resin | Coating | |
|---|---|---|---|---|
| | temperature | concentration | speed | Mean diameter |
| Resin | [° C.] | [wt %] | [cm/sec] | [μm] |
| PVA-205 | 60 | 20 | 23.36 | 95.13 |
| | | | 4.03 | 94.44 |
| | | | 1.44 | 90.55 |

### Example 3-1

An optical member with a concave lens array was fabricated under the following conditions.

As a hardenable fluid there was prepared 3 g of the thermoplastic resin polyethylene (commercially available under the trade designation LDPE C13 from

Eastman Chemical Company, Japan). As the base mold there was used a nickel sheet having on the mold surface square pyramidal concavities with depths of 25 μm, apex angles of 90 degrees and square bases with side lengths of 50 μm, and arranged in a square lattice pattern at a pitch of 50 μm. The base mold was fabricated by the same method described in Example 1-1.

A heat knife coater was used to coat the heat-melted thermoplastic resin onto the base mold to form a coating layer. Specifically, it was heated to a temperature sufficient for the resin to exhibit an adequate flow property (140° C.), and a coating layer was formed on the base mold to a thickness of 200 μm at a coating speed of 16 cm/sec while trapping the air surrounding the base mold.

The coating layer was then cooled to room temperature (approximately 25° C.) together with the base mold to form a hardened layer. Next, the hardened layer was released from the nickel base mold to obtain an optical member having a concave lens array composed of the thermoplastic resin (a structure with an arranged pattern of concavities).

### Example 3-2

An optical member with a convex lens array was fabricated under the following conditions.

The optical member (structure with an arranged pattern of concavities) produced in Example 3-1 was used as the second mold, and the same ultraviolet curing resin used in Example 1-1 was coated onto the second mold to a thickness of 200 μm, after which a release-treated PET film with a thickness of 50 gm was laminated thereover.

Using the same ultraviolet lamp as in Example 1-1, ultraviolet rays were irradiated at 3450 mJ/cm² from the release-treated PET film side to polymerize the ultraviolet curing resin and obtain a hardened layer. The hardened layer was then released from the second mold to obtain an optical member having a convex lens array composed of the ultraviolet curing resin (a structure with an arranged pattern of convexities).

### Example 4-1

An optical member with a concave lens array, with the two-dimensional shape of each lens extending in one direction, was fabricated under the following conditions.

As the base mold there was used a silicone resin (commercially available under the trade designationTSE3466 from GE Toshiba Silicone Co.) base mold having a pattern of rectangular concavities with short side lengths of 80 μm, long side lengths of 320 μm, and depths of 120 μm arranged in a lattice fashion (short side direction pitch: 120 μm, long side direction pitch: 360 μm) (concavity pattern formation area: 691 mm×378 mm). The base mold was fabricated using a SUS plate with grooves formed by polishing by the same procedure as in Example 1-1.

An ultraviolet curing resin was used as the hardenable fluid. The ultraviolet curing resin was prepared by mixing 90 parts by weight of a polyester-based urethane acrylate monomer (commercially available under the trade designation EBECRYL8402 from Daicel-Cytec Co., Ltd.), 10 parts by weight of unsaturated fatty acid hydroxyalkyl ester-modified ε-caprolactone (commercially available under the trade designation Placcel™ FA2D from Dicel Chemical Industries, Ltd.) and 1 part by weight of a photopolymerization initiator (commercially available under the trade designation Irgacure 2959 from CIBA Specialty Chem. Inc.).

A laminating roller was used as the coating apparatus. The ultraviolet curing resin was dropped onto the base mold surface, a PET film was laminated thereover, and the roller was rotated on the PET film while moving it in the direction relatively parallel to the long sides of the base mold concavities, to spread the ultraviolet curing resin onto the entire surface of the base mold. A spacer was used to adjust the gap between the PET film and roller to 500 μm so that the weight of the roller would not be directly applied to the base mold. The roller movement speed was 100 mm/sec. Thus, a coating layer was formed on the base mold while trapping gas bubbles in each of the concavities of the base mold. It was then irradiated with ultraviolet rays at 3450 mJ/cm² through the PET film to polymerize and harden the ultraviolet curing resin to form a hardened layer. Next, the hardened layer was released from the silicone base mold to obtain an optical member having concave lenses and grooves surrounding them (a structure with an arranged pattern of concavities).

FIG. 18 shows an SEM photograph of the obtained optical member. A lens array was obtained having concave curved surfaces extending in one direction corresponding to each concavity of the base mold.

### Example 4-2

An optical member having a convex lens array with the two-dimensional shape of each lens extending in one direction was fabricated under the following conditions using the optical member obtained in Example 4-1 (the structure with the arranged pattern of concavities) as the second mold.

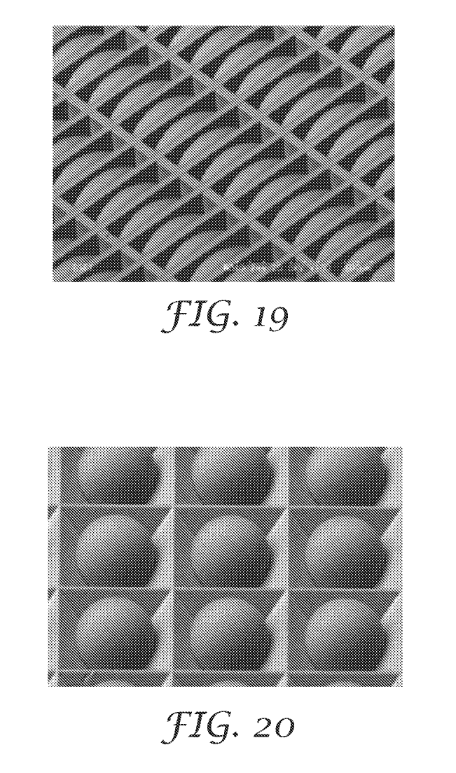

An ordinary temperature-hardening silicone resin (commercially available under the trade designation ELASTSIL RT601, two-solution type (mixing weight ratio: solution A:solution B=90:10), from Wacker AsahiKasei Silicone Co., Ltd.) was coated onto the second mold under the same conditions as in Example 1-2, and the coating layer was hardened by standing overnight (approximately 24 hours) at room temperature (approximately 25° C.). The hardened layer was released from the second mold to obtain an optical member having an arranged pattern of convexities obtained by inversion of the arranged pattern of concavities. FIG. 19 shows an SEM photograph of the obtained optical member. A convex lens array was obtained having shapes extending in one direction corresponding to each concavity of the base mold.

### Example 5-1

An illumination device was fabricated, having an optical member with a convex lens array obtained by replication of gas bubbles laminated on an organic EL panel. The optical member was fabricated under the following conditions.

As the base mold there was prepared a 50 mm-square nickel base mold having on the mold surface a pattern with square pyramidal concavities with apex angles of 90 degrees and square bases with side lengths of 100 μm, arranged in a square lattice pattern at a pitch of 100 μm. The nickel base mold was fabricated by the same method described in Example 1-1.

The nickel base mold surface was subjected to plasma treatment under the following conditions. Specifically, the base mold was first set on the sample stage in the chamber of a vacuum RF plasma treatment apparatus (commercially available under the trade designation WAF′R/BATCH7000 Series from Plasma-Therm Co.), and the chamber was sealed. After reducing the internal pressure of the chamber to below 10 mTorr (1.333 Pa) with a rotary pump, a mass flow meter was used to introduce 300 SCCM (Standard CC per min) of tetramethylsilane (TMS) and 30 SCCM of oxygen (O₂) into the chamber. Here, “SCCM” means the flow rate (CC/min) at 1 atmosphere (1,013 hPa), 25° C. After the flow rate stabilized, the butterfly valve was adjusted to control the chamber to approximately 100 mTorr (13.33 Pa), and then plasma treatment was conducted for 30 seconds with an output of 1000 W. The chamber was opened to the air and the plasma treated base mold was removed.

The hardenable fluid used was the same type of ultraviolet curing resin used in Example 1-1, and it was coated onto the plasma treated base mold under the conditions described above. The coating was accomplished using a knife coater in the same manner as Example 1-1 at a coating speed of 16 cm/sec to a thickness of 150 μm, and this was followed by lamination with a 250 μm-thick PET film coated with a primer (trade name: N-200, product of Sumitomo 3M). Next, a UV lamp was used for irradiation of ultraviolet rays at 3450 mJ/cm² from the primer-treated PET film side, for hardening of the ultraviolet curing resin. The hardened layer was then released from the nickel base mold to obtain a structure (first structure) having an arranged pattern of concavities obtained by replication of gas bubbles.

The first structure with the arranged pattern of concavities obtained by the process described above was used as the second mold, a 20 wt % PVA-217 aqueous solution was prepared as the same type of water-soluble resin used in Example 1-2 and coated onto the second mold, and degassing was performed. The coating was accomplished using a knife coater in the same manner as Example 1-2, for coating at a coating speed of 16 cm/sec to a thickness of 500 μm. This was followed by drying for 2 hours in an oven at 60° C., and then further drying by standing overnight (about 12 hours) at room temperature (approximately 25° C.). The dried hardened layer was released from the second mold to obtain a structure (second structure) having an arranged pattern of convexities obtained by inversion of the first structure.

Also, the second structure with the arranged pattern of convexities obtained by the process described above was used as a third mold, an ordinary temperature hardening silicone resin (commercially available under the trade designation ELASTSIL RT601, two-solution type (mixing weight ratio: solution A:solution B=90:10), from Wacker AsahiKasei Silicone Co., Ltd.) was coated onto the third mold and degassing was performed. The coating was accomplished using a knife coater in the same manner as Example 1-2 at a coating speed of 16 cm/sec to a thickness of 150 μm, and the coated mold was laminated with a 38 μm-thick release agent-coated PET film (commercially available under the trade designation PUREX A31 from Teijin-DuPont Films Japan Ltd.). After coating, it was allowed to stand for 24 hours at room temperature (25° C.) for hardening. The hardened layer was released from the third mold to obtain a structure (third structure) having an arranged pattern of concavities.

Using the third structure as a fourth mold and an ultraviolet curing resin composed mainly of urethane acrylate, prepared to a refractive index of 1.56 upon hardening, the resin was coated and the coated resin was hardened, under the same conditions as Example 1-2, and release from the fourth mold yielded an optical member composed of an acrylic resin with an arranged pattern of convexities, having a refractive index of 1.56. FIG. 20 shows an SEM photograph of the obtained optical member.

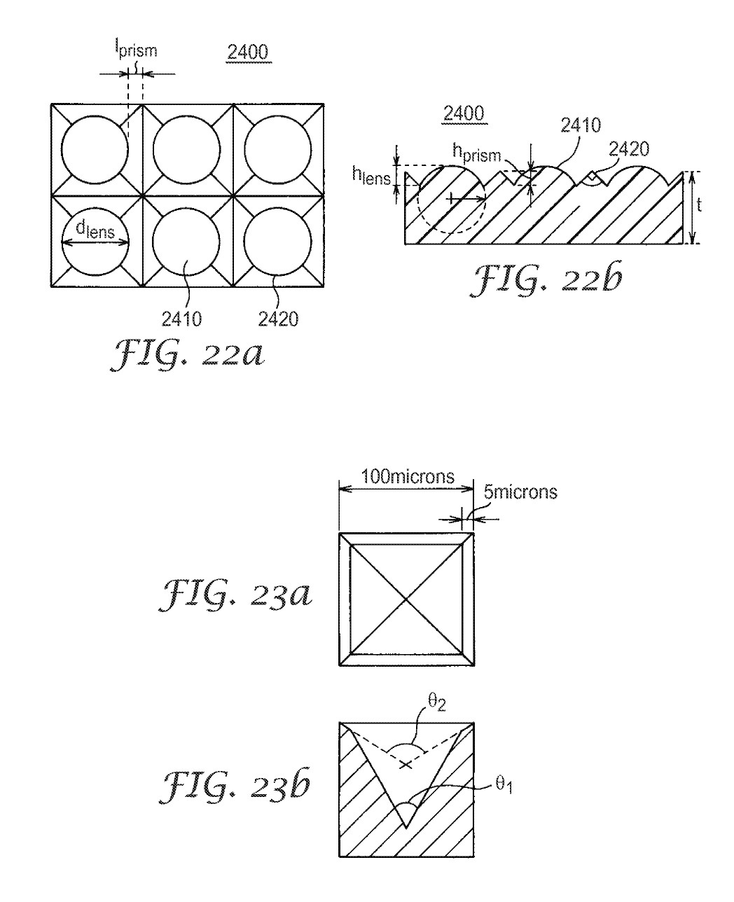

FIG. 22a shows a plan schematic diagram of the obtained optical member 2400, and FIG. 22b shows a cross-sectional schematic diagram of the same. As seen in these drawings, the optical member 2400 contained essentially hemispherical convex lenses 2410 obtained by replication of gas bubble shape in the first replication step using the base mold, and prism sections 2420 surrounding them, formed by replication of the square pyramidal slanted surface shape forming the concavities of the base mold. The dimensions of the optical member 2400 shown in FIG. 22a and FIG. 22b were measured from an SEM image. The lens maximum diameter dlens was 63.0 μm, the lens curvature radius r was 32.3 μm, the prism minimum width Lprism was 18.5 μm, the lens height hlens was 42.9 μm, the prism apex angle Op was 90 degrees, the prism height hprism was 21.0 μm and the optical member thickness t was 150 μm. The numerical values were determined by measuring at 5 locations randomly selected from the photomicrograph, and calculating the average.

A 140 mm×140 mm organic EL panel (product of the Research Institute for Organic Electronics) was also obtained. The organic EL panel was a surface emission device developed for illumination, and its emission color was red. It had an organic light emitting element formed on a soda glass board with a refractive index of 1.53, and the organic EL element layer had a laminated structure in the order of transparent electrode (ITO layer)/organic positive hole injection layer/organic positive hole transport layer/organic luminescent layer/organic electron injection-transport layer/metal electrode layer, from the glass panel side.

On the glass panel of the organic EL panel there was first dropped several droplets of a refraction liquid with a refractive index of 1.56 (commercially available under the trade designation Shimadzu Device Corp from Shimadzu Device Corp.), onto the emitter surface, and a roller was used to manually spread it out over the entire luminous surface. Next, the aforementioned optical member comprising an acrylic resin with a refractive index of 1.56 was attached onto the glass panel (in the same orientation shown in FIG. 10a) via the refraction liquid, while taking care to avoid introduction of air at the interface, in such a manner that the lens formed surface (main surface) served as the light-emitting side, in order to obtain an illumination device.

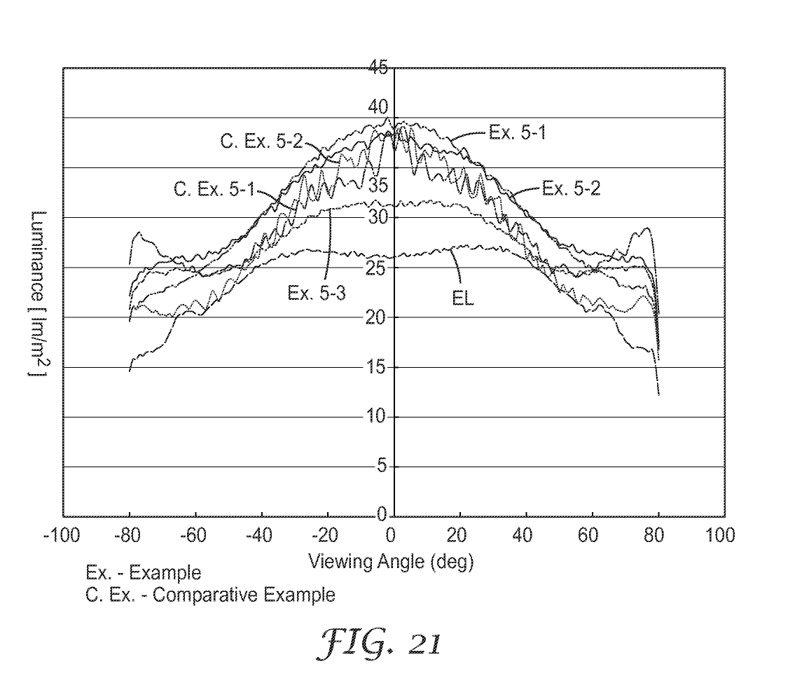

A current of 0.03 A was applied at 9.5 V to the organic EL panel of this illumination device to produce light emission, and the luminance and light distribution properties were measured using an optical measuring device (commercially available under the trade name EZ Contrast 160R from ELDIM). For comparison, light emission was generated with the organic EL panel alone, without attaching the optical member, and the total luminous flux and maximum luminous intensity ratio were measured and defined as 100%. In the illumination device with the optical member attached, the integrated intensity ratio was increased to 126% and the maximum luminous intensity ratio increased to 146%, compared to before attachment. The measurement results are shown in Table 4 and FIG. 21.

### Example 5-2

An illumination device was fabricated, having an optical member with a convex lens array obtained by replication of gas bubbles laminated on an organic EL panel.

The optical member was fabricated under the following conditions. First, a nickel mold that had been plasma treated under the same conditions as Example 5-1 was used as the base mold, and the same type of ultraviolet curing resin used in Example 1-1 was coated onto the base mold under the same conditions as Example 1-1, trapping gas bubbles in each of the concavities of the nickel mold, and then the coating layer was exposed to ultraviolet irradiation to form a hardened layer. The hardened layer was released from the nickel base mold to obtain a structure (first structure) having an arranged pattern of concavities.

Next, using the first structure having the arranged pattern of concavities obtained by the process described above as the second mold, an ordinary temperature-hardening silicone resin (commercially available under the trade name ELASTSIL RT601, two-solution type (mixing weight ratio: solution A:solution B=90:10), from Wacker AsahiKasei Silicone Co., Ltd.) was coated onto the second mold under the same conditions as in Example 1-2, and the coating layer was hardened by standing overnight (approximately 24 hours) at room temperature (approximately 25° C.). The hardened layer was released from the second mold to obtain an optical member having an arranged pattern of convexities obtained by inversion of the arranged pattern of concavities. The dimensions of the obtained optical part were approximately the same as the optical member of Example 5-1. The obtained optical member had an auto-adhesive property and its refractive index was 1.41.

The obtained adhesive optical member was attached onto the same type of organic EL panel as in Example 5-1 on the glass panel which was the luminous surface, without using a refraction liquid and taking care to avoid introduction of air at the interface, to obtain an illumination device.

A current of 0.03 A was applied at 9.5 V to the illumination device in the same manner as Example 5-1 to produce light emission, and the luminance and light distribution properties were measured using an optical measuring device (commercially available under the trade name EZ Contrast 160R from ELDIM). In the illumination device with the optical member attached, the integrated intensity ratio was increased to 125% and the maximum luminous intensity ratio increased to 142%, compared to before attachment. The measurement results are shown in Table 4 and FIG. 21.

### Example 5-3

An illumination device was fabricated, having an optical member with a concave lens array obtained by replication of gas bubbles laminated on an organic EL panel.

The optical member was fabricated under the following conditions. A nickel mold that had been plasma treated under the same conditions as Example 5-1 was used as the base mold, and the same type of ultraviolet curing resin used in Example 1-1 was coated onto the base mold under the same conditions as Example 1-1, trapping gas bubbles in each of the concavities of the nickel mold, and then the coating layer was exposed to ultraviolet irradiation to form a hardened layer. The hardened layer was released from the nickel base mold to obtain a structure (first structure) having an arranged pattern of concavities.

The first structure with the arranged pattern of concavities obtained by the process described above was used as the second mold, a 20 wt % PVA-217 aqueous solution was prepared as the same type of water-soluble resin used in Example 2-1 and coated onto the second mold, and degassing was performed. The coating was accomplished using a knife coater in the same manner as Example 1-2, for coating at a coating speed of 16 cm/sec to a thickness of 500 μm. This was followed by drying for 2 hours in an oven at 60° C., and then further drying by standing overnight (about 12 hours) at room temperature (approximately 25° C.). The dried hardened layer was released from the second mold to obtain a structure (second structure) having an arranged pattern of convexities obtained by inversion of the first structure.

Also, the second structure with the arranged pattern of concavities obtained by the process described above was used as a third mold, an ordinary temperature hardening silicone resin (commercially available under the trade name ELASTSIL RT601, two-solution type (mixing weight ratio: solution A:solution B=90:10), from Wacker AsahiKasei Silicone Co., Ltd.) was coated onto the third mold under the same conditions as in Example 1-2, and degassing was performed. The coating layer was hardened by standing overnight (approximately 24 hours) at room temperature (approximately 25° C.). The hardened layer was released from the third mold to obtain an optical member having an arranged pattern of concavities obtained by inversion of the arranged pattern of concavities. The dimensions of the obtained optical part were approximately the same as the optical member of Example 5-1. The obtained optical member had an auto-adhesive property and its refractive index was 1.41.

The obtained adhesive optical member was attached onto the same type of organic EL panel as in Example 5-1 on the glass panel which was the luminous surface, without using a refraction liquid and taking care to avoid introduction of air at the interface, to obtain an illumination device.

A current of 0.03 A was applied at 9.5 V to the illumination device in the same manner as Example 5-1 to produce light emission, and the luminance and light distribution properties were measured using an optical measuring device (commercially available under the trade name EZ Contrast 160R from ELDIM). In the illumination device with the optical member attached, the integrated intensity ratio was increased to 117% and the maximum luminous intensity ratio increased to 117%, compared to before attachment. The measurement results are shown in Table 4 and FIG. 21.

### Comparative Example 5-1

An illumination device was fabricated comprising a prism sheet with an arrangement of square pyramidal concavities, obtained by an ordinary replication process, laminated on an organic EL panel.

The prism sheet was fabricated under the following conditions. Using a nickel convex mold on which were arranged square pyramids with square bases having 100 μm sides and heights of 50 μm, at a pitch of 100 μm, an ordinary temperature-hardening silicone resin (commercially available under the trade name ELASTSIL RT601, two-solution type (mixing weight ratio: solution A:solution B=90:10), from Wacker AsahiKasei Silicone Co., Ltd.) of the same type used in Example 4-2 was coated onto the mold under the same conditions as in Example 1-2, and after degassing, the coating layer was hardened by standing overnight (approximately 24 hours) at room temperature (approximately 25° C.). The hardened layer was released from the mold to obtain a prism sheet. The obtained prism sheet had the size and inverted shape of the mold surface, and its thickness was 150 μm. The prism sheet also had an auto-adhesive property and a refractive index of 1.41.

The obtained adhesive prism sheet was attached onto the same type of organic EL panel as in Example 5-1, on the glass panel which was the luminous surface, without using a refraction liquid and taking care to avoid introduction of air at the interface, to obtain an illumination device.

A current of 0.03 A was applied at 9.5 V to the illumination device in the same manner as Example 5-1 to produce light emission, and the luminance and light distribution properties were measured using an optical measuring device (commercially available under the trade name EZ Contrast 160R from ELDIM). In the illumination device with the prism sheet attached, the integrated intensity ratio was increased to 112% and the maximum luminous intensity ratio increased to 150%, compared to before attachment. The measurement results are shown in Table 4 and FIG. 21.

### Comparative Example 5-2

An illumination device was produced comprising a prism sheet with an arrangement of square pyramidal convexities, obtained by an ordinary replication process, laminated on an organic EL panel.

TABLE 4

| | | | | Maximum |
|---|---|---|---|---|
| | Refractive | Prism apex | Integrated | luminous |
| | index of | angle | intensity | intensity |
| | optical member | (deg) | ratio | ratio |
| Example 5-1 | 1.56 | 90.0 | 126% | 146% |
| Example 5-2 | 1.41 | 90.0 | 125% | 142% |
| Example 5-3 | 1.41 | 90.0 | 117% | 117% |
| Comp. Ex. 5-1 | 1.41 | 90.0 | 112% | 150% |
| Comp. Ex. 5-2 | 1.41 | 90.0 | 118% | 147% |
| Organic EL alone | — | — | 100% | 100% |

The prism sheet was fabricated under the following conditions. Using a nickel concave mold on which were arranged in a lattice fashion square pyramids with square bases having 100 μm sides and heights of 50 μm, at a pitch of 100 μm, an ordinary temperature-hardening silicone resin (commercially available under the trade name ELASTSIL RT601, two-solution type (mixing weight ratio: solution A:solution B=90:10), from Wacker AsahiKasei Silicone Co., Ltd.) of the same type used in Example 4-2 was coated onto the mold under the same conditions as in Example 1-2, and after degassing, the coating layer was hardened by standing overnight (approximately 24 hours) at room temperature (approximately 25° C.). The hardened layer was released from the mold to obtain a prism sheet. The obtained prism sheet had the size and inverted shape of the mold surface, and its thickness was 150 μm. The prism sheet also had an auto-adhesive property and a refractive index of 1.41.

The obtained adhesive prism sheet was attached onto the same type of organic EL panel as in Example 5-1, on the glass panel which was the luminous surface, without using a refraction liquid and taking care to avoid introduction of air at the interface, to obtain an illumination device.

A current of 0.03 A was applied at 9.5 V to the illumination device in the same manner as Example 5-1 to produce light emission, and the luminance and light distribution properties were measured using an optical measuring device (commercially available under the trade name EZ Contrast 160R, from ELDIM). In the illumination device with the prism sheet attached, the integrated intensity ratio was increased to 118% and the maximum luminous intensity ratio increased to 147%, compared to before attachment. The measurement results are shown in Table 4 and FIG. 21.

### Example 6-1

This is an example of applying an optical member having a concave lens array obtained by replication of gas bubble shape to a device with a lattice-like light-shielding pattern, such as a black matrix.

An optical member with a concave lens array was fabricated under the following conditions. The same type of ultraviolet curing resin used in Example 1-1 was used as the hardenable fluid. As the base mold there was used a nickel mold having concavities arranged in a square lattice fashion. A two-dimensional configuration of a concavity is shown in FIG. 23a, and a cross-sectional view is shown in FIG. 23b. As shown in these drawings, each concavity had a structure with two different square pyramids having base sides of 100 μm and different apex angles, laminated in the direction of depth of the concavities, and the angles of the slanted surfaces of the concavities were adjusted to two levels. On the bottom section of the concavity there was formed a square pyramid with a cross-sectional apex angle 01 of 60 degrees, and on the shallow end, that is near the opening of the concavity there was formed a square pyramid with a cross-sectional apex angle θ2 of 130 degrees. The nickel base mold used was one fabricated by the same method as described in Example 1-1. That is, grooves were formed in the copper sheet with a cutting machine, and then the copper sheet was immersed in the oxidizing agent to oxidize the copper sheet surface. After forming a nickel layer on the copper sheet surface by electrodeposition, the nickel layer was released from the copper sheet to obtain a nickel mold.

The ultraviolet curing resin and base mold were used for coating of the ultraviolet curing resin onto the base mold under the same conditions as Example 1-1. Specifically, a knife coater was used for coating to a thickness of 150 μm on the base mold at a coating speed of 16 cm/sec, while trapping gas bubbles in each of the concavities. At the same time, it was laminated with a primer-treated (N-200 by Sumitomo 3M) 250 μm-thick PET film. Next, a UV lamp was used for irradiation of ultraviolet rays at 3450 mJ/cm² from the primer-treated PET film side, for polymerization and hardening of the ultraviolet curing monomer. After polymerization, the hardened layer was released from the nickel mold together with the PET film to obtain an optical member having a concave lens array composed of the ultraviolet curing resin (a structure with an arranged pattern of concavities). Around each concave lens obtained by replication of the gas bubbles there was formed a prism section as a slanted surface obtained by replicationring the shape of the opening of the nickel mold. Separately, as a member with a lattice-like light-shielding pattern (black matrix), there was prepared a PET film (commercially available under the trade name FUJIPLOTTER FILM HG FF R175 from FujiFilm Corp.), having a lattice-like light-shielding pattern with short sides of 100 μm, long sides of 300 μm and line widths of 20 μm printed on the front side with black ink, and having the back side treated with a primer (commercially available under the trade name X34-1802 from Shin-Etsu Chemical Co., Ltd.). The PET film had an actual film thickness of 175 μm, but protective layers with thicknesses of 4 μm and 5 μm covered the back side and the printed layer of the front side, for a total thickness of 184 μm.

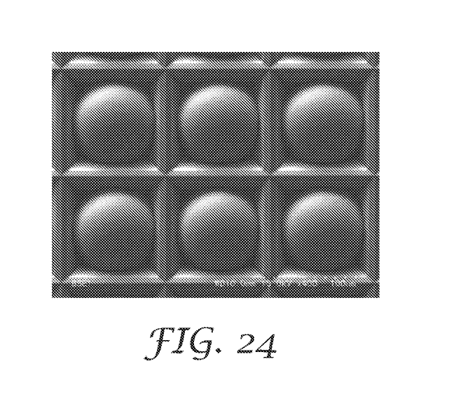

Using the structure with an arranged pattern of concavities obtained by the process described above as the second mold, a knife coater was used to coat the same type of ordinary temperature hardening silicone resin used in Example 4-2 onto the second mold under the same conditions as in Example 1-2, while simultaneously laminating a coating layer onto the PET film having the lattice-like light-shielding pattern. During this time, it was oriented so that the surface of the PET film without the formed lattice-like light-shielding pattern was the bonding surface with the optical member, and adjusted so that the concave lens sections of the optical member were positioned on the openings of the lattice-like light-shielding pattern when viewed from above, with the light-shielding sections and the prism sections of the optical member disposed in a flush manner on both sides. The coating layer was hardened overnight (approximately 12 hours) at room temperature (approximately 25° C.), and the hardened layer was then released from the second mold together with the PET film. Thus, a composite member was obtained comprising an optical member with an arranged pattern of convexities, and a lattice-like light-shielding pattern. The obtained optical member had a refractive index of 1.41. FIG. 24 shows an SEM photograph of the surface of the obtained optical member alone.

The obtained composite member, having the same device construction as shown in FIG. 12a (except for the liquid crystal display 1250), with irradiated with directional light and an optical measuring device (trade name: EZ Contrast 160R by ELDIM) was used for optical measurement. The evaluation results are shown in Table 5. When applied to a member with a lattice-like light-shielding pattern, the optical member comprising lenses and prisms prepared in the example had a utilization efficiency improved by at least about 20% compared to the non-applied one (Comparative Example 6-1).

### Comparative Example 6-1

A member was prepared identical to the one used in Example 6-1, having a lattice-like light-shielding pattern on one side and a primer-treated PET film on the other side. The primer-treated side of the PET film was coated with the same silicone resin as used in Example 6-1, to a thickness of 150 μm. The coating layer was then hardened by standing overnight (approximately 24 hours) at room temperature (approximately 25° C.). An irregularity-free flat silicone resin layer was thus formed on the back side of the PET film with the lattice-like light-shielding pattern. Table 5 shows the evaluation results after optical measurement of the obtained member using an optical measuring device (commercially available under the trade name EZ Contrast 160R, from ELDIM).

TABLE 5

| | Optical | Light transmitted by light- | Transmitted light |
|---|---|---|---|
| | member | shielding pattern | increase |
| | present | (lm/m²) | [%] |
| Comp. Ex. 6-1 | NA | 1090 | 0 |
| Example 6-1 | Existing | 1337 | 22.6 |

### Example 7

An input device sample for a cellular phone was prepared, employing an optical member with a concave lens array obtained by replication of gas bubble shape as the light guide.

An optical member according to the invention was fabricated by the following method.

First, as the base mold, there was prepared a laminated sheet with a two-layer structure (commercially available under the trade name TWO LAYER COPPER CLAD SUBSTRATE, from Japan Interconnection Systems Limited) having a 20 μm-thick copper foil laminated on a 75 μm-thick polyimide film. The polyimide layer of the laminated sheet was drilled by laser working (Tosei Electrobeam Co., Ltd.) to form round cylindrical concavities with hole diameters of approximately 30 μm-50 μm. Thus, a base mold was fabricated as shown in FIG. 14a and FIG. 14b, having a concavity arrangement pattern matching the arrangement of input keys of a standard cellular phone. The number of concavities formed in each region of the base mold corresponding to the light guiding region 1410 in FIG. 14b differed depending on the location of the corresponding key, but at least 100 or more concavities were arranged two-dimensionally in each region.

The base mold was used, otherwise under the same conditions as Example 1-1, to fabricate an optical member having a concave lens array, using an ultraviolet curing resin as the hardenable fluid. The obtained optical member had concave lenses obtained by replication of gas bubble shape at locations corresponding to the concavities of the base mold.

The optical member was incorporated as a light guide in an input device sample having the construction shown in FIG. 15, and subjected to an operating test. Satisfactory front luminance was confirmed for almost all of the input keys arranged on the input screen.

### Example 8

A microlens sheeting capable of synthesizing a floating image using an optical member that includes a convex lens array obtained by replication of gas bubble shape was prepared.

### Preparation of the Microlens Sheeting Base Material

First, a sheet-like first structure having a pattern of concavities produced by replication of gas bubble shape using the following procedure was prepared, using a base mold.

As the base mold, a laminated sheeting with a two-layer structure including a copper foil with a thickness of 20 μm laminated on a polyimide layer with a thickness of 25 μm was prepared (commercially available under the trade name TWO LAYER COPPER CLAD SUBSTRATE, from Japan Interconnection Systems, Ltd.). The polyimide layer of the laminated sheeting was processed using a laser to produce holes in a region with a side length of 100 mm (processing by Tosei Electrobeam Co., Ltd.), giving the resulting base mold a matrix pattern of conic concavities. FIG. 27a is a partial cross-sectional view showing an obtained base mold 2700 and FIG. 27b is a partial plan view of the same. The concavities formed in the base mold 2700 had a depth (Hd) of 25 μm, a concavity top part opening diameter (Dt) of 53 μm, a concavity bottom part opening diameter (Db) of 42 μm, and a concavity pattern pitch (Pt) of 60 μm.

As in Example 1-1, an ultraviolet curing resin was prepared by mixing 90 parts by weight of a polyester-based urethane acrylate monomer (commercially available under the trade name EBECRYL8402, from Daicel-Cytec Co., Ltd.), with 10 parts by weight of unsaturated fatty acid hydroxyalkyl ester-modified s-caprolactone (commercially available under the trade name Placcel™ FA2D from Dicel Chemical Industries, Ltd.) and 1 part by weight of a photopolymerization initiator (commercially available under the trade name Irgacure 2959 from CIBA Specialty Chem. Inc.).

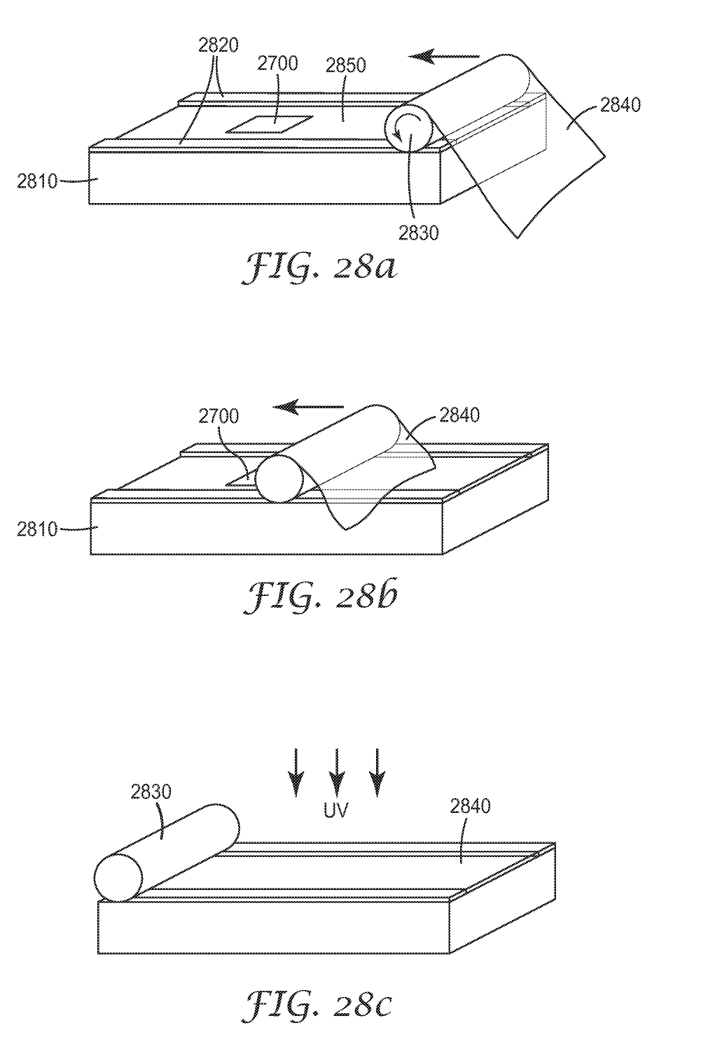

As shown in FIG. 28a, the base mold 2700 was placed on a surface plate 2810 having a smoothness of ±5 μm and including suction holes with a diameter of 1 mm and an interval of 120 mm, and suction was applied via the suction holes using a rotary pump to fix the base mold 2700 in place. Thereafter, as a spacer 2820, a stainless steel sheet with a thickness of 800 μm and a PET film with a thickness of 188 μm were placed at both ends of the base mold 2700. A laminating roller 2830 with a diameter of 200 mm, a weight of 300 kg, a length of 1500 mm and a 5 mm covering of silicon rubber provided to prevent static electricity from forming on a surface thereof was placed at one end of the surface plate 2810. As shown in FIG. 28a, with the PET film set under the laminating roller 2830, the ultraviolet curing resin 2850 was placed uniformly onto the surface plate 2810 along one edge of the base mold on the laminating roller 2830 side of the base mold 2700. Thereafter, the laminating roller 2830 was rotated and moved at speed of 1.42 mm/sec in the direction of the arrow in FIG. 28a by a servo motor connected at both ends. As shown in FIG. 28b, as the PET film 2840 was laminated to the base mold 2700 the ultraviolet curing resin 2850 was simultaneously coated onto the base mold 2700. Thus, gas bubbles were trapped in each of the concavities in the base mold 2700.

As shown in FIG. 28c, the ultraviolet curing resin 2850 was irradiated with ultraviolet light (365 nm) from a UV lamp via the laminated PET film 2840 to polymerize and cure the ultraviolet curing resin.

The polymerized and cured ultraviolet resin layer was removed from the base mold 2700, giving a structure including a replicated surfaces of curved concavities formed by the gas bubbles trapped between the concavities and the base mold and grooves therearound, or in other words a sheet-like first structure having a pattern of concavities in the surface thereof.

Next, the first structure formed from the ultraviolet curing resin layer obtained with the aforementioned process was used as a second mold. An ordinary temperature-curing silicone resin (refraction index 1.41; commercially available under the trade name ELASTSIL RT601, two-solution type (mixing weight ratio: Solution A : Solution B=90:10), from Wacker AsahiKasei Silicone Co., Ltd.) was coated onto the second mold. Coating was then performed using a knife coater at a coating speed of 16 cm/sec to obtain a coating layer with a thickness of 70 μm. Thereafter, the surrounding area was degassed by pressure reduction to 1000 Pa or less for about 15 minutes.

Next, a PET film having aluminum deposited thereon (commercially available under the trade name Metalumy TS#100 from Toray Advanced Film Co., Ltd.) to a thickness of 100 μm and a front surface coated with a with primer (commercially available under the trade name X34-1802 from Shin-Etsu Chemical Co., Ltd.) to a thickness of 3 μm was laminated to a front surface of the silicon resin layer, and the arrangement was left for 24 hours at room temperature (approximately 25° C.) to cure.

The cured layer was removed from the second mold to obtain the microlens sheeting for forming three dimensional images. The obtained microlens sheeting had a layer structure including a microlens array formed from the silicon resin (refractive index: 1.41) and a radiation sensitive material layer formed by the PET film with the layer of deposited aluminum. The microlens array had a microlens pattern such as that shown in FIG. 25b, including a pattern of convex lens curved surfaces and partition walls therearound. The height difference Dh between the height of the partition walls and the height of the convex lens curved surfaces in the microlens array was approximately 5 μm. The average thickness of the microlens array, or the average distance between the top of the convex lens curved surface and the front side of the radiation sensitive layer was measured to be 72 μm using a thickness gauge, which was a value approximately equal to a focal length of the convex lenses in the microlens array.

### Forming the Composite Three-Dimensional Image

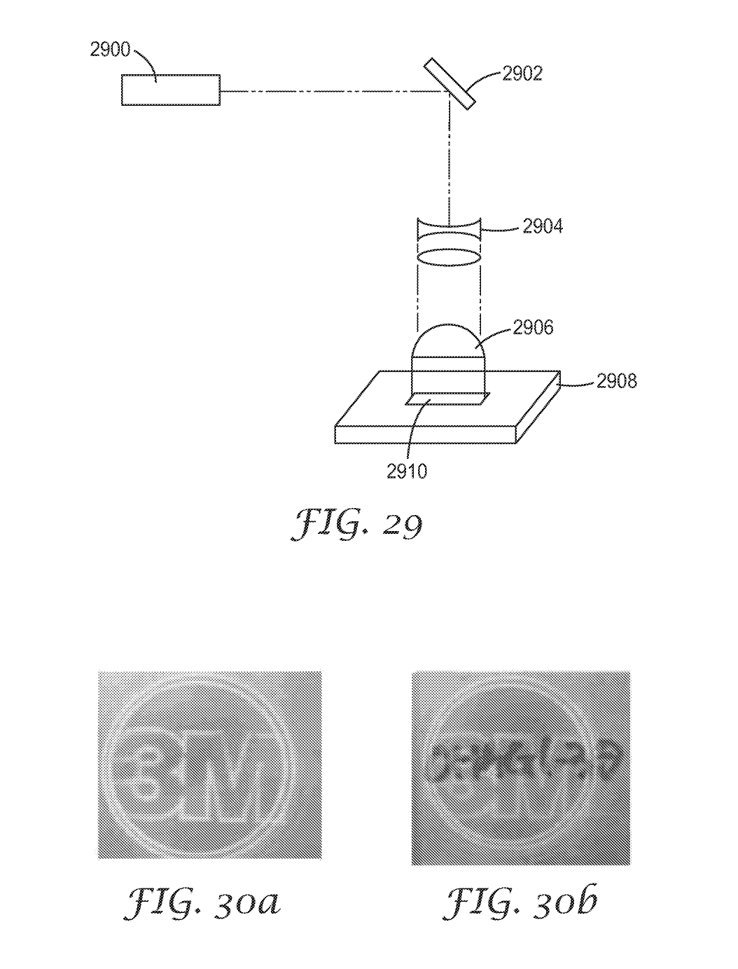

Next, the floating image was formed using the obtained microlens sheeting using the method described in Example One of “Sheeting with Composite Image that floats” described in patent gazette WO01/063341. Specifically, an optical train such as that shown in FIG. 29 was used. A Q-switched Nd:YAG laser 2900 with a basic wavelength of 1047 nm (commercially available under the trade name EdgeEave INNOSLAB™ type IS4I-E laser device (Nd: YLF crystal) from Analytical Group of Companies) was used to irradiate the microlens sheeting 2910 installed on a sample stage 2908 whose position can be adjusted on three axes X, Y, and Z, via a 99% reflective mirror 2902, a 5× beam expansion telescope 2904, and an aspherical lens 2906 with a numerical aperture of 0.64 and a focal length of 39.0 mm. The laser and the optical train were installed at a linear mortor stage system, which was the commercially available AGS 15000 brand (manufactured by Areotech Inc., Pittsburgh Pa.), and were moved. Note also that the laser has a pulse width of 10 ns or less and a repetition frequency of from 1 to 3000 Hz. The microlens sheeting 2910 was installed on the sample stage 2908 with the surface of the convex lens array facing upwards. In this example, the aspherical lens 2906 was set up so that the focal point thereof was at a position 1 cm above the microlens sheeting 2910. To control an energy density of the irradiation of the microlens sheeting, a LabMax™—top power meter and EneryMax™ 50 mm diameter sensors manufactured by Coherent Inc., Bridgeport, Oregon were used. The laser output was adjusted to obtain a laser irradiation energy density of approximately 8 milijoules/square centimeter (8 mJ/cm²) at a position 1 cm from the focal point of the aspherical lens 2906.

A commercially available A3200 controller manufactured by Aerotech Inc, Pittsburgh Pennsylvania was used to move the sample stage 2908 and control the pulse-controlling voltage supplied to the laser 2900. To draw the floating image on the microlens sheeting, the laser was pulsed while adjusting the X, Y, and Z stages to move the sample stage 2908 in the two-dimensional X and Y directions. Here, the laser beam was used to draw the characters “3M” on the radiation sensitive layer of the microlens sheeting. The sample stage was moved at a speed of 50.8 cm/min, for a laser pulse rate of 10 Hz.

### Installing the Protective Material

As the protective material, after drawing on the microlens sheeting was finished, a PET film having a thickness of 50 μm (commercially available under the trade designation Lumirror-QT79 from Toray Advance Film Co. Ltd.) and a front surface pre-coated with silicone resin (commercially available under the trade designation X34-1802 from Shin-Etsu Chemical Co. Ltd.) having a thickness of 3 μm was laminated, using a roller, to the microlens sheeting. Thus, microlens sheeting for forming a three-dimensional image and coated with PET film was obtained. The PET film was supported by the partition walls forming the microlens array so that the front surfaces of the microlenses did not make contact with the protective film and an air layer was formed above each of the microlenses.

### Evaluation of the Microlens Sheeting

The shape of the obtained microlens array was measured using an optical microscope (commercially available under the trade designation BX51 from Olympus Co., Ltd.). Specifically, a radius of a curvature r of each of the convex lenses, a height of the lens portions hl and a height of the partition wall portions hw were measured. The measurements were performed at two different locations by taking photographs at 50× magnification and finding an average value thereof. According to the results, r was 22.3 μm, hl was 19.3 μm, and hw was 22.4 μm.

A lens number and lens density were then measured at two different locations by taking photographs at 10× magnification using the same optical microscope. According to the results, it was possible to confirm that the obtained microlens array had a lens density of 30509 units/cm². For comparison, measurements under the same conditions were made on an existing microlens sheeting product which used glass beads (commercially available under the trade designation Scotch Lite® 680-10 from Sumitomo 3M Ltd.), as a microlens sheeting for forming a three-dimensional image. A lens diameter was 70 μm and the lens density was 15385 units/cm².

The visibility of the image was confirmed for the case that the microlens sheeting with images of characters drawn thereon was lit from the rear surface with a fluorescent light, and for the case that the microlens sheeting was lit the from the front by room lighting (fluorescent lighting). In the case of lighting from the rear surface with the fluorescent light, transmitted light forms the image. In the case of the lighting from the front with fluorescent lighting, light reflected by the layer of deposited aluminum forming the radiation sensitive film forms the image. However, it was confirmed in both cases that an image of the drawn “3M” appeared to float above the microlens sheeting sharply and with high contrast. The visibility of the same drawn image was also confirmed in a microlens sheeting which had been laminated with a PET film as a protective material. There was very little difference in the visibility of the drawn image. FIG. 30a is a photograph of the floating image obtained using the microlens sheeting without the PET film. FIG. 30b is a photograph of the floating image obtained using the microlens sheeting which had been laminated with the PET film. The microlens sheeting shown in FIG. 30b has characters written thereon using an oil-based pen. From the photograph, it can be seen that the drawn “3M” characters appear in front of the characters written using the oil-based pen.

When the PET film was laminated as the protective material, a scratch was made by dragging a fingernail across the surface of the PET film. However, because the microlenses themselves were not affected by the scratch, the visibility of the drawn image was not affected. The image was also confirmed for a case in which the front surface of the protective film was completely coated using an oil-based pen (Makki™, manufactured by Zebra Co., Ltd. Tokyo, Japan). The microlens sheeting was left in this condition for 1 minute, and the protective film was then wiped ten times in the same direction using paper wiper (Kimuwaipu™ S-200 manufactured by Nippon Paper Crecia Co., Ltd., Tokyo, Japan) soaked in isopropyl alcohol. In this case too, the visibility of the inscribed image was not affected.

1. An optical member comprising:
a main surface; and
a microlens array on the main surface, wherein the microlens array is formed using a replication process that employs a mold comprising a plurality of gas bubbles arranged on a transfer surface.

2. An optical member according to claim 1, wherein the microlens array comprises, concave lenses or convex lenses formed by replication of gas bubble shape.

3. An optical member according to claim 2, wherein the concave lenses or convex lenses are arranged in a lattice fashion on the main surface.

4. An optical member according to claim 2, wherein
the mold is further provided with slanted surfaces surrounding the gas bubbles, and
the microlens array has a prism section formed by replicating the slanted surfaces surrounding the gas bubbles.

5-6. (canceled)

7. An optical member comprising:
a main surface,
a plurality of convex lenses formed by replication of gas bubble shape, arranged on the main surface, and
partition walls adjacent to each of the convex lenses and surrounding each of the convex lenses.

8. An optical member according to claim 7, wherein the partition walls have sides that are perpendicular to the direction of the plane of the main surface.

9. An optical member according to claim 7, wherein the partition walls have prism sections with surfaces that are slanted with respect to the direction of the plane of the main surface.

10. An optical member comprising:
a main surface,
a plurality of concave lenses formed by replication of gas bubble shape, arranged on the main surface, and
grooves adjacent to each of the concave lenses and surrounding each of the concave lenses.

11-15. (canceled)

16. An optical device comprising:
a luminescent member and
an optical member according to claim 1 disposed on the light-emitting side of the luminescent member.

17. An illumination device comprising:
a transparent base material with a refractive index greater than 1;
a luminescent member that emits light through the transparent base material, and
an optical member according to claim 1, disposed on the transparent base material.

18. An illumination device according to claim 17, wherein the luminescent member comprises a light emitting element which is either a light emitting diode or an organic electroluminescent element.

19. An illumination device according to claim 17, wherein the optical member is disposed on the light-emitting side of the luminescent member via a pressure-sensitive adhesive material layer.

20. A display device comprising
a light-shielding pattern and
an optical member according to claim 1 disposed on the light-incident side to the light-shielding pattern.

21. A display device according to claim 20, wherein
the light-shielding pattern comprises a lattice-like arrangement pattern, and
the optical member comprises a lattice-like arrangement pattern of convex lenses or concave lenses corresponding to the lattice-like arrangement pattern.

22. A display device according to claim 20, which further comprises
a backlight device and
a display panel with picture elements arranged two-dimensionally,
wherein the light-shielding pattern is disposed between the backlight device and the display panel, and the optical member is disposed between the backlight device and the light-shielding pattern.

23. A display device according to claim 22, wherein the picture element is a liquid crystal device.

24. A display device according to claim 23, wherein the optical member has an arrangement pattern of lenses corresponding to the arrangement pattern of picture elements of the display panel.

25. An input device comprising:
a input screen with an arrangement of a plurality of input keys,
a light source, and
a light guide member comprising an optical member according to claim 1, which is disposed under the input screen and directs light from the light source to the regions on the input screen corresponding to each of the input keys.

26. A sheeting comprising:
a microlens array having a main surface and a plurality of convex lenses formed by replication of gas bubble shape arranged on the main surface, wherein each of the convex lenses is adjacent to and surrounded by partition walls that are higher than the convex lenses;
a protective material disposed on the microlens array so as to supported by the partition walls; and
a radiation sensitive layer disposed on a surface that is on an opposite side of the main surface of the microlens array.

27. The sheeting according to claim 26, further comprising a composite image that appears to a naked eye to float at least above or below the sheeting.
